(19) United States
(12) Patent Application Publication
(10) Pub. No.: US 2021/0383403 A1
(43) Pub. Date: Dec. 9, 2021

(54) UV, SOUND POINT, iA OPERATING SYSTEM

(71) Applicant: Federal Law Enforcement Development Services, Inc., St. Cloud, MN (US)

(72) Inventor: Felicity-John C. Pederson, St. Cloud, MN (US)

(73) Assignee: Federal Law Enforcement Development Services, Inc., St. Cloud, MN (US)

(21) Appl. No.: 17/406,524

(22) Filed: Aug. 19, 2021

Related U.S. Application Data
(63) Continuation-in-part of application No. 17/386,818, filed on Jul. 28, 2021.
Application No. 17/386,818 is a continuation of application No. 16/695,458, filed on Nov. 26, 2019.
Application No. 16/695,458 is a continuation of application No. 16/030,329, filed on Jul. 9, 2018, now Pat. No. 10,521,801.
Application No. 16/030,329 is a continuation of application No. 14/597,648, filed on Jan. 15, 2015, now abandoned.
(60) Provisional application No. 61/927,663, filed on Jan. 15, 2014.
(60) Provisional application No. 63/068,177, filed on Aug. 20, 2020.

(51) Int. Cl. G06Q 30/00; G06F 3/01; H04L 12/28; G06F 1/16; G06F 3/03

(52) U.S. Cl. CPC G06Q 30/00; G06F 3/011; H04L 12/282; G06F 1/163; G06F 3/0325; G06F 3/013; G06F 3/014; G06F 3/017; G06F 3/0304; G06F 3/012

(57) ABSTRACT

A ubiquitous Network Platform/Computer Operating System where traditional screen displayed Control Icons are replaced with real world Virtual Reality “life like” 3D animations/simulations, all items within forming working Control icons connected to real time/spatial coordinates, the simulation being simultaneously updated by, but not limited to, iA and any/all connected service appliances, program applications, outside collected contributing data sources and any other I.O. forum.

### CROSS-REFERENCE TO RELATED APPLICATIONS

This application is a continuation-in-part application and claims priority from U.S. patent application Ser. No. 17/386618, filed Jul. 28, 2021, which is a continuation application from U.S. patent application Ser. No. 16/695458, filed Nov. 26, 2019, currently abandoned, which is a continuation application from U.S. patent application Ser. No. 16/030329, filed Jul. 9, 2018, U.S. Pat. No. 10,521,801 issued Dec. 31, 2019, which is a continuation application from U.S. patent application Ser. No. 14/597648 filed on Jan. 15, 2015, currently abandoned. U.S. patent application Ser. No. 14/597648 filed on Jan. 15, 2015 claims priority to U.S. Provisional Application Ser. No. 61/927663 filed Jan. 15, 2014, the entire contents of all of the above identified patents, patent applications and provisional patent applications being expressly incorporated herein by reference in their entireties.

This application also claims the benefit of U.S. Provisional Patent Application Ser. No. 63/068177, which was filed Aug. 20, 2020 the entire contents of which being incorporated herein by reference in its entirety.

### BACKGROUND OF THE INVENTION

In the past, individuals have been required to physically walk to a building system control device to alter a building system status. Two examples of building system control devices may be light switches and/or a thermostat. In many cases a building system is electrically coupled to a building system control device by wires.

In some modern structures, the control of a building system may be provided by an on-site computer, provided that a user may identify the current location of the electronic file for the control of the building system on the facility computer or server.

In the past it has been difficult for individuals to locate a building system control device, because either the building system and/or the building system control device has been stored within folders, sub-folders, and/or individual files on a facility computer system. In these instances, extensive time and expenditures have been required in the training of individuals to access and manipulate building system control items. In addition, cultural, educational and language barriers have made training problematic and costly in some instances.

In the past, individuals have been required to be physically present in a building or at a retail location to engage in the control of a building system or engage in commercial activities. Alternatively, in order to engage in commerce, an individual was required to use an electronic device to visit a website to browse or search for pictorial images or descriptions of items for purchase. An individual was required to use an actuator such as a mouse or button to select items for purchase. The individual was then required to type or enter electronic payment information to complete a transaction.

It has not been known to provide a user-friendly system to engage in building system control management, or to improve commerce, through the provision of an operating exchange having an operating system in communication with a visible light embedded communication system.

Also in the past it has been difficult and costly to engage in cleaning activities especially related to thorough cleaning to minimize the existence of bacteria or viruses within an area. It has not been known to combine a pulsed visible light embedded communication system with an ultraviolet cleaning system. I has not been known to use a pulsed embedded visible light communication system to generate illumination as well as communication capabilities during one period of time and then to provide ultraviolet germicidal irradiation at another time to an area without replacement of existing infrastructure.

The art referred to and/or described above is not intended to constitute an admission that any patent, publication or other information referred to herein is “prior art” with respect to this invention. In addition, this section should not be construed to mean that a search has been made or that no other pertinent information as defined in 37 C.F.R. § 1.56(a) exists.

All U.S. patents and applications and all other published documents mentioned anywhere in this application are incorporated herein by reference in their entireties.

Without limiting the scope of the invention, a brief description of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided for the purposes of complying with 37 C.F.R. § 1.72.

### GENERAL DESCRIPTION OF THE INVENTION

In one embodiment the invention is directed to an infrastructural apparatus operating system including a personal electronic device having a device camera, a device sensor, a device controller, a device display, a device photodetector, a device identifier, and plurality of device light emitting diodes. The device camera observes a physical environment and the device controller regulates the plurality of device light emitting diodes. The device camera transmits images of the physical environment within a device issued pulsed visible light embedded communication signal where the images include element images.

A visible light embedded communication fixture has a plurality of fixture light emitting diodes, a fixture controller, a fixture memory, a fixture identifier and a fixture photodetector. The fixture photodetector receives the device issued pulsed visible light embedded communication signal and the fixture controller stores the images and the element images in the fixture memory within a cyber environment. The fixture controller assigns control icons to the element images within the cyber environment. The fixture controller regulates the plurality of fixture light emitting diodes transmitting a fixture generated pulsed visible light embedded communication signal having the cyber environment and the control icons.

The device photodetector receives the transmitted fixture generated pulsed visible light embedded communication signal having the cyber environment and the control icons where the device controller processes the fixture generated pulsed visible light embedded communication signal having the cyber environment and the control icons and transfers the cyber environment and the control icons onto the device display.

The device sensor detects motion of the personal electronics device, and the device controller processes the motion and identifies at least one of the control icons where the device controller regulates the plurality of device light emitting diodes transmitting the processed motion and the identification of the at least one control icon within another device issued pulsed visible light embedded communication signal. The fixture photodetector receives the another device issued pulsed visible light embedded communication signal having the processed motion and the identification of the at least one control icon.

The fixture controller retrieves from the fixture memory at least one of the element images or at least one operation assigned to the at least one control icon where the fixture controller transmits a further fixture generated pulsed visible light embedded communication signal having the at least one element image or the at least one operation assigned to the at least one control icon.

The device photodetector receives the further generated fixture pulsed visible light embedded communication signal having the at least one element image or the at least one operation assigned to the at least one control icon.

The device controller activates the device display and communicates the at least one element image or the at least one operation assigned to the at least one control icon onto the device display.

In another embodiment the fixture controller compares the physical environment to the cyber environment and updates the cyber environment to reflect alteration of a location of the control icon within the cyber environment.

In another embodiment, the personal electronic device has a device projector in communication with the device display.

In yet another embodiment the sensed motion is selected from the group essentially consisting of a gesture, an eye movement, a head movement, an arm movement, a leg movement, a rotational movement, a vertical movement, a swipe movement, and any combination thereof.

In another alternative embodiment, the personal electronic device is a set of transceiver glasses or goggles.

In another embodiment the device identifier includes device location information and the device pulsed visible light embedded communication signal includes the device identifier.

In another embodiment, the fixture identifier includes fixture location information and the fixture pulsed visible light embedded communication signal includes the fixture identifier.

In another embodiment, each update of said cyber environment includes an update identification tag, where the update identification tag includes at least one of date, time and location information.

In another embodiment, at least one of the fixture memory and the fixture controller are in communication with an evolving database.

In another embodiment, an infrastructural apparatus operating system includes a visible light embedded communication fixture having a plurality of fixture light emitting diodes generating light in the visible spectrum, a plurality of fixture ultraviolet light emitting diodes generating light in the ultraviolet spectrum, a fixture controller, a fixture memory, a fixture identifier and a fixture photodetector. The fixture photodetector receives a received pulsed visible light embedded communication signal and the fixture controller regulates the plurality of fixture light emitting diodes generating light in the visible spectrum and transmitting a fixture generated pulsed visible light embedded communication signal. The fixture memory includes stored parameters regulating activation of the plurality of fixture ultraviolet light emitting diodes where the light in the ultraviolet spectrum provides germicidal irradiation to a surface. The received pulsed visible light embedded communication signal including a signal origin identifier and an activation authorization code which enables emission of the light in the ultraviolet spectrum. The fixture generated pulsed visible light embedded communication signal including the fixture identifier.

In another embodiment, the at least one sensor is selected from the group essentially consisting of a light sensor, a motion detector, a heat source sensor, a temperature sensor, an air movement sensor, a sound sensor, and combinations thereof.

In another embodiment, at least one of the fixture controller, the fixture memory and the at least one sensor is in communication with an evolving database.

In another embodiment, the evolving database issues a command signal terminating emission of the light in the ultraviolet spectrum.

In another embodiment, an input device is in communication with the fixture controller, the input device authorizing emission of the light in the ultraviolet spectrum.

In another embodiment, the input device is selected from the group essentially consisting of a keypad code, a thumb print scanner, a card reader, a palm scanner, a retinal scanner, a voice scanner, a biometric scanner and combinations thereof.

These and other embodiments which characterize the invention are pointed out with particularity in the claims annexed hereto and forming a part hereof. However, for further understanding of the invention, its advantages and objectives obtained by its use, reference should be made to the drawings which form a further part hereof and the accompanying descriptive matter, in which there is illustrated and described embodiments of the invention.

### BRIEF DESCRIPTION OF THE DRAWINGS

FIG. 1 is a block diagram of one embodiment of LED light control assembly and system;

FIG. 2 is a detailed view of an LED light source in any exemplary embodiment of the present invention;

FIG. 3 is an isometric view of one alternative embodiment of a USB dongle or key interface device;

FIG. 4 is a front view of one alternative embodiment of an LED light fixture;

FIG. 5 is an isometric view of one an alternative embodiment of an electronic device;

FIG. 6 is an isometric view of one alternative embodiment of a control unit;

FIG. 7 is a block diagram of an alternative embodiment of the LED light control assembly and system;

FIG. 8 is a block diagram of an alternative embodiment of the LED light control assembly and system;

FIG. 9 is a block diagram of an alternative embodiment of a communication signal including an identifier;

FIG. 10 is a block diagram of an alternative embodiment of the LED light control assembly and system;

FIG. 11 is a block diagram of an alternative embodiment of the LED light control assembly and system;

FIG. 12 illustrates by hierarchal chart of one embodiment of an illustrative sample of the types of data communications to which the present invention may be applied either singly or in any combination;

FIG. 13 illustrates by hierarchal chart of an alternative embodiment of an application of the teachings of the present invention;

FIG. 14 illustrates by hierarchal chart one embodiment of an illustrative application of the present invention;

FIG. 15 illustrates by block diagram an alternative embodiment of an application of the teachings of the present invention;

FIG. 16 illustrates by block diagram one alternative embodiment of the LED light control assembly and system;

FIG. 17 illustrates by block diagram one alternative embodiment of the LED light control assembly and system;

FIG. 18 illustrates by block diagram an alternative embodiment of a data packet in accord with an embodiment of the LED light control assembly and system;

FIG. 19 is an alternative block diagram of an alternative embodiment of the LED light control assembly and system;

FIG. 20 is an alternative block diagram of an alternative embodiment of the LED light control assembly and system;

FIG. 21 is an alternative block diagram of an alternative embodiment of the LED light control assembly and system;

FIG. 22 is an alternative waveform diagram of an alternative duty cycle for the LED light control assembly and system;

FIG. 23 is an isometric view of one embodiment of the visible light communication transceiver glasses;

FIG. 24 is a pictorial representation of one embodiment of the invention where an individual is interfacing with an operating exchange in communication with a visible light communication system to engage in electronic commerce activities;

FIG. 25 is a pictorial representation of one embodiment of the invention where an individual interfacing with the operating exchange has selected and is about to enter into a virtual retail location as depicted in FIG. 24;

FIG. 26 is a pictorial representation of one embodiment of the invention where an individual interfacing with the operating exchange is virtually moving down an isle of a virtual retail location as depicted in FIG. 25;

FIG. 27 is a pictorial representation of one embodiment of the invention where an individual interfacing with the operating exchange has selected a virtual item from the virtual isle of FIG. 26 and is proceeding to a customer service location of FIG. 28;

FIG. 28 is a pictorial representation of one embodiment of the invention where an individual interfacing with the operating exchange is communicating with a customer service representative at a customer service location to complete and an electronic commercial transaction;

FIG. 29 is a pictorial representation of one embodiment of the invention where an individual is interfacing with an operating exchange for a structure;

FIG. 30 is a pictorial representation of one embodiment of the invention where an individual interfacing with the operating exchange is virtually entering into a structure;

FIG. 31 is a pictorial representation of one embodiment of the invention where an individual interfacing with the operating exchange is virtually moving down a hallway of a structure as depicted in FIG. 30;

FIG. 32 is a pictorial representation of one embodiment of the invention where an individual interfacing with the operating exchange is virtually entering into an office along the virtual hallway of FIG. 31, within the structure;

FIG. 33 is a pictorial representation of one embodiment of the invention where an individual interfacing with the operating exchange is virtually accessing a control element access panel of a building operating system within a virtual office of FIG. 32;

FIG. 34 is a pictorial representation of one embodiment of the invention of an LED light fixture of a visible light embedded communication system including a camera, microphone, and LED light panel;

FIG. 35 is an isometric view of one embodiment of an interface for communication with one embodiment of an operating exchange;

FIG. 36 is a pictorial representation of one embodiment of an interface for an operating exchange in communication with a visible light embedded communication system;

FIG. 37 is a block diagram of one alternative embodiment of the invention;

FIG. 38 is a block diagram of one alternative embodiment of the invention;

FIG. 39 is a block diagram of one alternative embodiment of the invention;

FIG. 40 shows a schematic view of one embodiment of an intelligent video/audio observation and identification database system according to the present invention;

FIG. 41 depicts one embodiment of an environmental view of a room equipped with an intelligent observation and identification database system according to the present invention;

FIG. 42 is a block diagram of an alternative embodiment of the Communication System;

FIG. 43 is an alternative exploded view of one embodiment of a transmitter/receiver of an LED light fixture;

FIG. 44 is a detail partial cut away isometric view of one alternative embodiment of an outer lens retainer assembly; and

FIG. 45 is a detail partial cut away isometric view of one alternative embodiment of an inner lens retainer assembly.

### DETAILED DESCRIPTION OF THE PREFERRED EMBODIMENTS

While this invention may be embodied in many different forms, there are described in detail herein specific alternative embodiments of the invention. This description is an exemplification of the principles of the invention and is not intended to limit the invention to the particular embodiments illustrated. For the purposes of this disclosure, like reference numerals in the figures shall refer to like features unless otherwise indicated.

In each of the embodiments discussed below, the light emitting diodes (hereinafter LEDs) 124, 2100 may generate different wavelengths to provide different colors of light. For example LEDs 124, 2100 may emit light in he visible spectrum while a subset of LEDs 125 may emit light in the ultraviolet spectrum to provide germicidal irradiation to improve sterilization of surfaces against bacteria or viruses. The LEDs 124, 125, 2100 are in communication with a controller 20 which may be configured to select the wavelength for the LEDs 124, 125, 2100 to be illuminated.

It should be noted that in some embodiments, the LEDs 124, 2100 can both emit and receive light. In such an embodiment, the LEDs 124, 2100 can act both as a transmitter or receiver.

Through the use of red, green and blue LEDs (RGB), the color temperature of an LED light panel or LED light fixture 10 may be adjusted or controlled, and may be varied in real time without making any hardware or apparatus changes. Instead, power applied to the RGB LEDs is adjusted to favor one or another of the LEDs.

A variety of physical and electrical configurations are contemplated herein for LED light source 161. As illustrated in FIG. 2, light source 161 may replace a standard fluorescent tube light fixture. This can be accomplished by replacing the entire fixture, such that ballasts and other devices specific to fluorescent lighting are replaced.

In one embodiment, line voltage, such as 120 VAC at 60 Hertz as used in the United States, may pass through LED base 2050, which may be designed to insert directly into a standard fluorescent socket, such as, for exemplary purposes only, and not limited thereto, the standard T8 and T12. In such case, either RGB LEDs 2100 are arranged and wired to directly operate from line voltage to provide necessary power to the LED light source 161.

Standard LED lights come in a variety of color temperatures, from ‘warm’ yellows to ‘cool’ whites. In facilities such as hospitals and offices, color temperature may significantly affect mood and productivity, where making a long-term commitment to a color temperature when converting to LED lighting may be a strong barrier to entry into LED lighting. In at least one embodiment, the LEDs within a visible light embedded communication (hereinafter a VLEC) system have adjustable color temperature for the emitted light. In some embodiments, the VLEC LED light fixtures 10 may be programmed to mimic the changing color temperate of sunlight as the day progresses or as the seasons progress throughout the year.

In some embodiments, a variety of physical and electrical configurations are contemplated herein for VLEC LED light fixture 10 (FIG. 4). The VLEC LED light fixture 10 may replace a standard fluorescent tube light fixture.

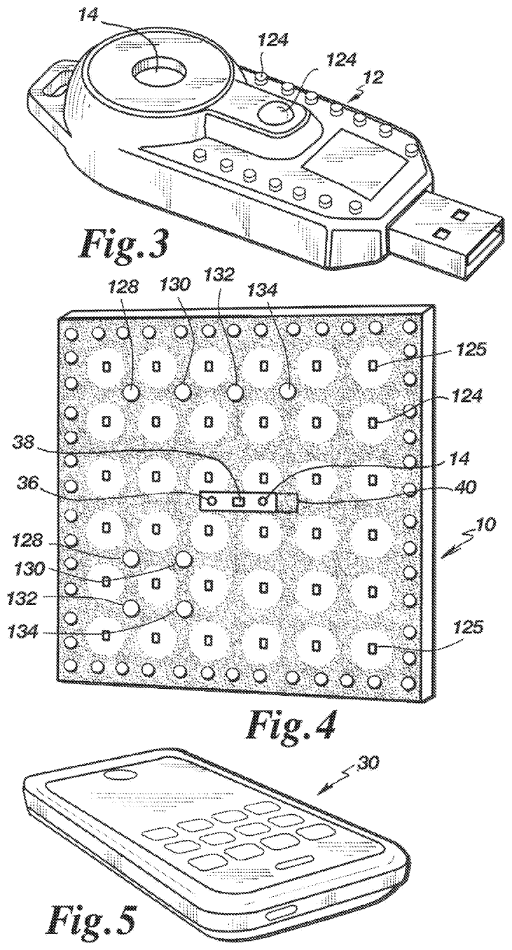

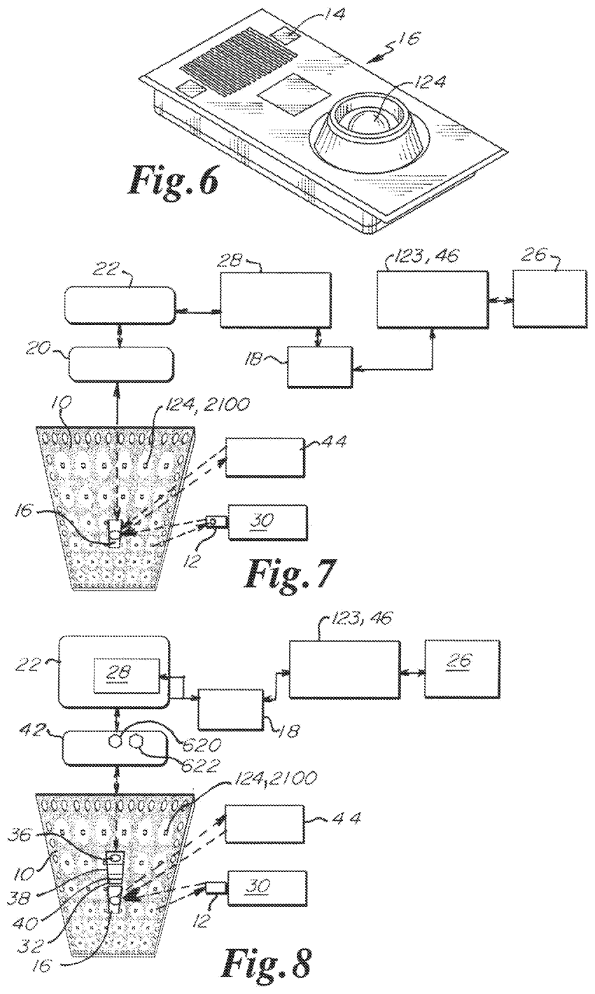

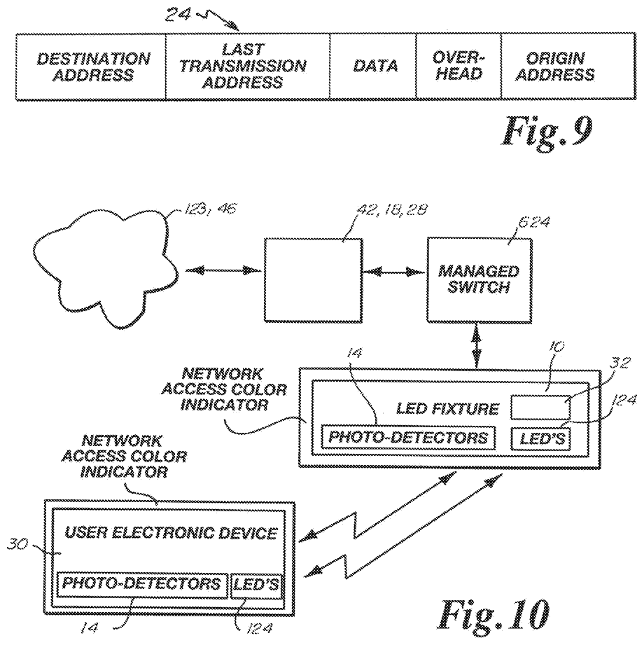

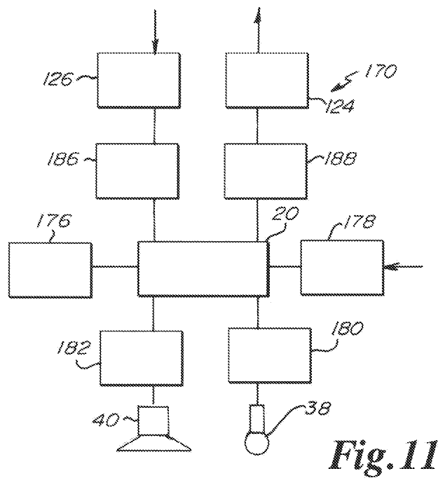

In some embodiments, each VLEC LED light fixtures 10, LED dongle or key device 12 (FIG. 3), and each control unit 16 (FIG. 6) includes processors/controllers 20, LEDs 124, and photodetectors 14 being in communication with a pulsed visible light embedded communication system. The pulsed visible light embedded communication system receives pulsed light signals and generates pulsed light signals to communicate information as to the status of a VLEC LED light fixture 10, dongle or key 12 or control unit 16. In some embodiments, each control unit 16 of a building system, such as a lighting system, heating system, security system, public address system, monitoring system, metering system, recording system, speaker system, elevator system to name a few, either has an integral LED photodetector 14 and/or controller 20 and LEDs 124 for visible pulsed light embedded communication. Each control unit 16 may be retro-fitted to include an LED communication device such as a dongle or key device 12 to receive pulsed LED light embedded communication signals from a VLEC LED light fixture 10, and to generate and communicate LED light embedded communication transmissions for receipt by another VLEC LED light fixture 10 to provide information in response to a status request.

In some embodiments, each control unit 16 may include sensors, meters, controllers/processors 20, photodetectors 14, and LEDs 124 to receive and to generate pulsed light embedded communication signals to a facility control unit 18. In some embodiments, each facility control unit 18 may function to be electrically connected to, and in communication with, motors, devices, servo motors, solenoids, or other electronic devices which are used to alter the status of a building system or system element 44 such as a door lock, a thermostat, a light switch, an elevator control, a speaker, a microphone, a monitor to name a few. It should be noted that the identified elements for the control elements, building systems, system elements 44, or other identifiers herein are not intended to be exhaustive, and should be interpreted as expansive and are not intended to be limiting as to the specific elements or types of elements as identified herein.

In some embodiments each of the VLEC LED light fixtures 10 having a controller 20 and photodetector 14 provide the capability for embedded pulsed light communications with a client or electronic device 30 (FIG. 5). The client or electronic device 30 or USB interface devices 12, may be attached to laptops, computers or other electronic device through an electrical connection which may be a USD adapter/receiver. The drivers for those devices may be installed on another type of electronic device 30 such as a tablet, smart phone, computer or other electronic device with or without the use of an application or through an Ethernet connection.

In at least one embodiment the VLEC LED light fixtures 10 may be connected to a power unit 22 through an Ethernet plug. The Pro FTM signals, called the data, may be communicated over the same lines that are providing power prior to transmission through visible embedded pulsed light signals.

In some embodiments, the controller 20 on the VLEC LED light fixture 10 decode pulsed light embedded communication information. In some embodiments, the LED light fixture 10 receives OFTM signals and converts the signals into an Ethernet standard computer format which then may be injected down into a facility control unit 18.

In at least one embodiment each LED light fixture 10 will include one or more cameras 36, speakers 40, or microphones 38 and any combination thereof. In addition, in some embodiments a dongle device 12 will include a camera 36, microphone 38, or a speaker 40 or any combination thereof. In some embodiments, each light fixture control unit 16 or dongle device 12 may include voice activation and/or recognition software, facial recognition software and/or motion sensors or detectors which may be used to active one or more features on a VLEC LED light fixture 10, or to an electronic device 30 engaged to a dongle device 12.

In some embodiments an individual may activate and initiate illumination or pulsed VLEC signals by movement proximate to a VLEC LED light fixture 10 or dongle device 12. Movement relative to the position of the VLEC LED light fixture 10 or dongle device 12, or by speaking to the VLEC LED light fixture 10, or by speaking to the dongle device 12 or by facial recognition, motion recognition, or gesture recognition which may either activate or deactivate illumination or pulsed light communication. In some embodiments, the dongle devices 12 and/or the VLEC LED light fixture 10 with a controller 20 having facial recognition software, where illumination or pulsed light communications may be either initiated or terminated by a facial gesture, eye movement, movement of a head, entry into a space, shaking of a head, movement of a hand, arm, or other portion of a body, to name a few examples.

In some embodiments, an individual may initiate a communication such as a telephone call through the exclusive use of LED pulsed light embedded communications. In some embodiments, an individual may be able to initiate a voice and/or video communication with another individual by looking at a VLEC LED light fixture 10 or dongle device 12 and speaking terms such as “call John” where a real time voice, and/or voice and visual communication may be initiated. A microphone or sensor may detect a command. A controller may verify the command and the control server 26 or central processor may then establish a connection to another individual.

In at least one embodiment, the control server 26 may include or be in communication with a database of information to answer any inquiries of a user. LED pulsed light embedded communications may occur because each VLEC LED light fixture 10 and/or electronic device 30 interfaced with a dongle device 12 will include an identifier 24 (FIG. 8). Each identifier 24 may include a device identification number and/or may also include a location identifier, which may be active or static. In one embodiment the location identifier includes GPS location information, an account or premises number, and/or elevation information, unit numbers or another type of location or device identifier such as for example a numeric volume interfaced with a known database.

In some embodiments the identifier 24 may also include facility, environment, or type information which may be character designating for example that the communication or data transfer is issuing from a location or vehicle such as a building, boat or vessel, land vehicle, plane or satellite, or other device capable of identification.

In some embodiments, communications may occur through a control server 26 which may include location identification routing capabilities so that a pulsed VLEC signal may be efficiently routed from an origin address to a destination address through intermediate LED pulsed light receiving and generation units or VLEC LED light fixtures 10. The control server 26 may also have route optimization analysis software as well as LED pulsed light system usage software, so that optimal re-routing of a pulsed light communication signal may occur, and if necessary, may occur around a high volume traffic location, or to divert around an LED pulsed light receiving and generation unit or VLEC LED light fixture 10 being replaced or serviced.

In at least one embodiment, the dongle device 12 like the VLEC LED light fixture 10 includes, or is in communication with, voice recognition software, voice activation software, camera, facial recognition software, gesture recognition software, voice conversion software, motion recognition software and communication interface software, where an individual may activate an electronic device 30 through the dongle device 12 and the electronic device 30 will receive processed information as received and detected by the dongle device 12. The electronic device 30 then, as an option to a user, may re-transmit or re-communicate an original communication over a wireless telephone as known. In this embodiment, an individual may use a dongle device 12 as connected to an electronic device 30, where the individual is located at a location where direct pulsed light communication is not available, and the dongle device 12 may be used as the communication interface to transmit communication signals wirelessly, or through cellular telephone communications, microwave or otherwise, such as through a telecommunications satellite.

The VLEC LED light fixtures 10 may be connected back to the power unit 22. A power unit 22 may support up to sixteen VLEC LED light fixtures 10 at a time. The power units 22 inject power into the light fixtures 10 and the data leaving the power unit 22 travels back through wires, to a power unit controller 28.

In some embodiments, a room may include any number of VLEC LED light fixtures 10. Each VLEC LED light fixture 10 may be operating the same, or have a different settings resulting in different operation.

The dongle device 12 with the built in voice and/or facial recognition software in some embodiments, may function as security for the electronic device 30 preventing activation until such time an authorized user's voice of facial features are recognized.

In at least one embodiment, a camera 36 is integral to at least one VLEC LED light fixture 10 in a room. The camera 36 is in electrical communication with a controller 20 comprising motion, sound, light, or facial recognition software. The camera 36 in conjunction with the recognition software and the controller 20 may include one or more preset customized environmental settings, such as temperature, heating, cooling, and/or lighting to name a few.

In some embodiments, the controller 20 may include lighting or other environmental presets for activation in any combination of electronic devices 30 upon the facial recognition of one or more individuals within an area, where the camera 36 has recorded the image of the individual. In some embodiments, the controller 20 may be programmed to activate, deactivate, or issue an alarm if the camera 36 has recorded an image of an individual which is not recognized or authorized within a certain area or zone. In some embodiments, only one VLEC LED light fixture 10 in an area includes a camera 36 and in other embodiments, each or any combination of VLEC LED light fixtures 10 within an area includes a camera 36.

In at least one embodiment, the camera 36 on the VLEC LED light fixtures 10 which in turn are in communication with the controller 20, will recognize the departure or exit of an individual from a space or area, and will issue a deactivation command to turn a VLEC LED light fixture 10 off. The detection of the absence of an individual may also be accomplished through the processing of images from the camera 36 by the facial recognition software. It should be understood that the use of the camera 36 and facial and/or motion recognition processing for customization and/or regulation of an environment is not restricted to any particular area or environment and the types of uses are not restricted to the embodiments disclosed.

In other embodiments, the VLEC LED light fixtures 10 may be in communication with a control or system server 26 having access to databases of information. In this embodiment, an individual may verbally ask an LED light fixture 10 or dongle device 12 a question which is processed with voice recognition and converted into electrical signals recognizable by a computing device where a response to the verbal inquiry will be provided through a speaker 40 on the VLEC LED light fixture 10 or LED dongle device 12.

In some embodiments, the pulsed light communication system in communication with a control server 26 has an established user profile. Identification of the current user profile occurs through facial recognition and/or voice recognition software through the VLEC LED light fixture 10. The control server 26 based on the user profile may generate a communication through the VLEC LED light fixture 10 and initiate a communication through a speaker 40.

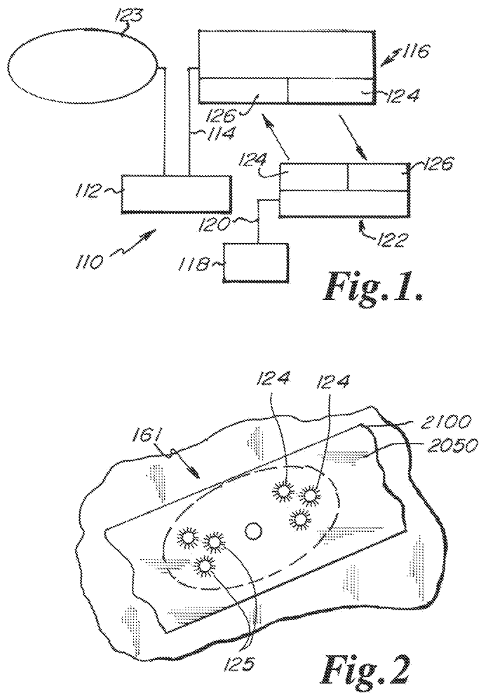

FIG. 1 depicts an exemplary embodiment 110 of an LED light and communication system. FIG. 1 shows a server PC 112 connected via a USB cable 114 to a server optical transceiver (XCVR) 116, and a client PC 118 connected via a USB cable 120 to a client optical transceiver 122. The server PC 112 is in communication with a network 123 via a CAT-5 cable, for example. The server optical XCVR 116 and the client optical XCVR 122 are substantially similar in at least one embodiment. An exemplary optical XCVR (or, simply, “XCVR”) circuit includes one or more LEDs 124 for transmission of light and one or more photodetectors 126 for receiving transmitted light. The term “photodetector” includes “photodiodes” and all other devices capable of converting light into current or voltage. The terms photodetector and photodiode are used interchangeably hereafter. The use of the term photodiode is not intended to restrict embodiments of the invention from using alternative photodetectors that are not specifically mentioned herein.

In some embodiments, the XCVR circuit further includes an amplifier for amplifying the optical signal received by the photodiode. The output of the amplifier may be fed into level shifting circuitry to raise the signal to TTL levels, for example.

In at least one embodiment, the optical XCVRs, or circuitry attached thereto, include modulation circuitry for modulating a carrier signal with the optical signal. Modulation can be used to eliminate bias conditions caused by sunlight or other interfering light sources. Digital modulation can be accomplished by using phase-shift keying, amplitude-shift keying, frequency-shift keying, quadrature modulation, data compression, data decompression, up converting, down converting, coding, interleaving, pulse shaping or any other digital modulation communication and/or signal processing techniques known by those of ordinary skill. Similarly, such XCVRs can include demodulation circuitry that extracts the data from the received signal.

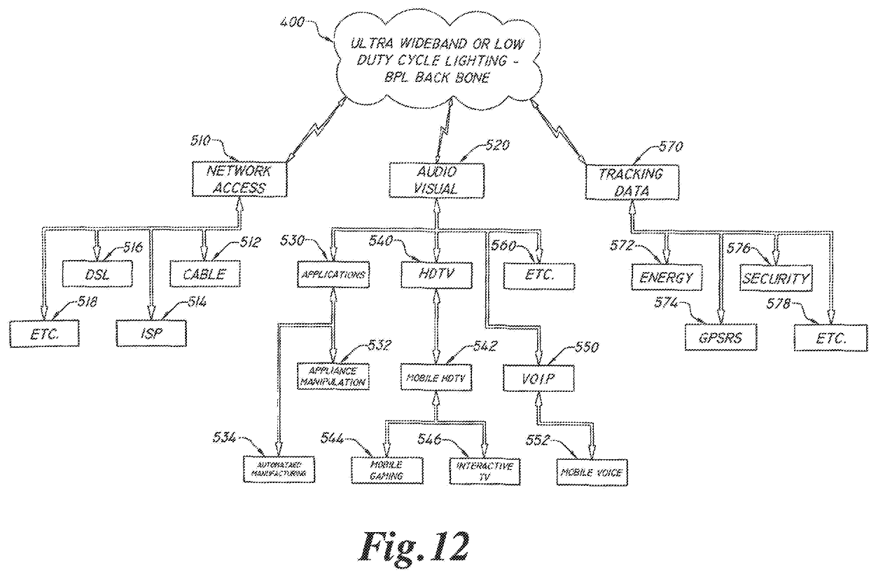

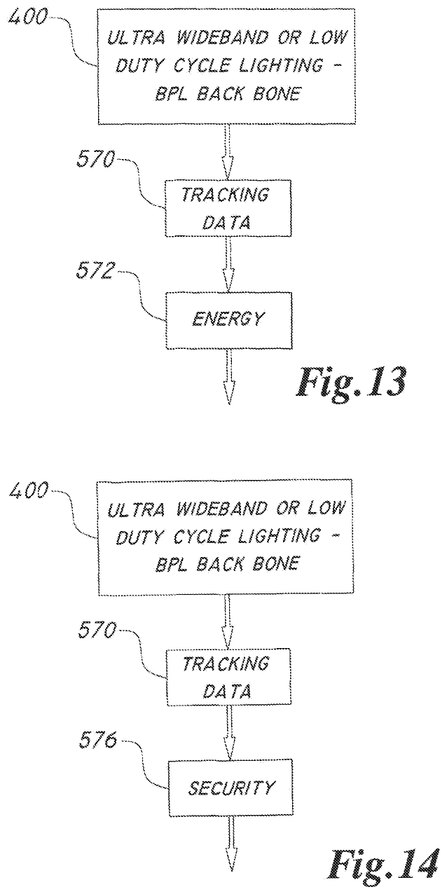

Some embodiments of an LED XCVR light fixture may include any or all of the following additional devices: a rechargeable battery 176, and a video camera 178, as shown in the simplified block diagram of FIG. 12. In at least one embodiment, the microphone 138 is in communication with an analog-to-digital converter (ADC)(not shown) for converting the analog speech input to a digital signal. An amplifier circuit 180 can be used to boost the microphone signal. The signal can be amplified prior to or after the ADC. In some embodiments, the speaker 140 is communication with a digital-to-analog converter (DAC)(not shown) for converting the received digital signal to an analog output. An amplifier circuit 182 can be used to boost the speaker signal. The signal may be amplified prior to or after the DAC.

The processor 20 converts the digital signals from the microphone/amplifier to data packets that may be used for transmission by the optical XCVR 116 and visible pulsed light embedded communication. Similarly, the processor 20 converts the data packets received by the optical XCVR 116 to audio out signals directed to the speaker 40. The processor 20 can convert data packets received from or directed to the video camera 178.

Furthermore, the optical XCVR 116 may include non-volatile memory (FLASHRAM, EEPROM, and EPROM, for example) that may store firmware, as well as text information, audio signals, video signals, contact information for other users, for example.

The optical XCVR 116 may include one or more photodetectors 126 for receiving transmitted VLEC LED light signals, and one or more LEDs 124 for transmitting VLEC LED light signals, as shown in FIG. 12. In some embodiments, an optical signal amplifier 186 is in communication with the photodetectors 126 to increase the signal strength of the received light signals. In at least one embodiment, the LEDs are in operative communication with an LED power driver 188, ensuring a constant current source for the LEDs.

In at least one embodiment, each and every optical XCVR 116 is embedded with a unique identifier 24, similar in principle to the MAC address of a computer, for example. The optical XCVR 116 broadcasts the unique identifier 24 at regular intervals, at irregular intervals or with each transmitted data packet.

There are numerous applications of such a design. For example, in some embodiments, an optical XCVR 116 may be engaged to a door lock. When a user with a portable electronic device having an optical XCVR approaches a locked door, a unique identifier 24 may be broadcast, and an optical XCVR in communication with the door lock may receive the identifier 24, and if acceptable, unlock or open the door. A table of acceptable identifier's 24 may be stored in a memory device that is in communication with, and accessible by, the door's optical XCVR. Alternatively, the door's optical XCVR may transmit an identifier 24 to a facility control unit 18 which compares a user's identifier 24 against a table of approved identifiers 24, and then sends a response either allowing or denying access.

Within the disclosure provided herein, the term “processor” refers to a processor, controller, microprocessor, microcontroller, mainframe computer or server, or any other device that can execute instructions, perform arithmetic and logic functions, access and write to memory, interface with peripheral devices, etc.

In some embodiments, optical XCVRs 116 may be placed in numerous locations as lighting sources. In some embodiments, an XCVR 116 as integral to a ceiling mounted or other type of light fixture may in turn be in direct communication with a computer, processor, microprocessor, mainframe computer or server, and/or other computing device through the use of wire, cable, optically via pulsed light communication, over a Broadband Over Power Line system or over any other type of communication system.

In one embodiment a series of XCVRs 116 are in communication with the system processor, mainframe computer or control server 26, through sequential transmission and receipt of pulsed light communication signals. In one embodiment the series of XCVRs 116 are in communication with the system processor, mainframe computer or control server 26, through the Broadband Over Power Line Communication System. In one embodiment the series of XCVRs are in communication with the system processor, mainframe computer or control server 26 through the use of cable, wire, or other communication media.

In one embodiment the communication system including the XCVR 116 may be incorporated into a hand held or portable unit. In other embodiments the communication system may be incorporated into a device such as a cellular telephone.

In accord with at least one embodiment of the invention, LEDs 124, 2100 are used to transmit through an optical communication channel several kinds of data, including identity, location, audio and video or any other type of information. The use of an optical communication link provides large available bandwidth, which in turn permits multiple feeds of personal communication between LED light sources and dongles or keys 12. The optical data is embedded within pulses of visible light which are transmitted at a frequency far in excess of those detectable by the human eye, and so a person is not able to detect any visible changes the perceived light quality or intensity as the data is being transferred. Additionally, because optical illumination is constrained by opaque objects such as walls, the location of an access dongle or key 12 and associated person can be restricted to a particular room, hallway or other similar space.

In some embodiments, an optical transceiver location is capable of precision identification to a room or LED room light fixture 10, for improved location identification including a vertical direction to an extent not previously available.

Each transmission of a communication pulsed light signal will include a code/identifier 24 representative of the originating XCVR 116 or origin location. Optionally additional intermediate XCVRs may add a communication pulsed light signal code or identifier 24 to identify intermediate locations during transmission of a VLEC signal.

In one embodiment, a control server 26 may initiate an inquiry to locate the identification code 24 corresponding to an optical XCVR 116. In this embodiment, the control server 26 would transmit a signal outwardly through the optically connected XCVRs 116 to request identification of a particular XCVR identification code 24. In one embodiment the inquiry may be limited to specific periods of time or other specific conditions such as location. In one embodiment each individual XCVR 116 upon receipt of the command inquiry may forward by pulsed light signals the identification codes 24 of all XCVRs within a particular area.

In accordance with another alternative embodiment of the present invention, building lighting may be modulated with time and date stamps or the like. In some embodiments, video recordings made within a system using modulated illumination which will have an optical watermark automatically embedded therein. The embedding of such identifiable signals ensures the integrity of video recordings.

Today's satellite navigated Global Positioning is augmented with the use of a Global Positioning System Routing System (GPSRS). The burden on GPS satellites may be reduced by embedding unique identifier information 24 along with pre-documented exact location of an entity or asset. The unique GPSRS identifier 24 may be incorporated into VLEC LED light fixtures 10 or fixture controllers 42, switches 624, facility control units 18, remote servers, power supplies 22, control servers 26 or any other electrical device 30 which may be in a communication chain for communication of information, data packets, or commands or other types of communication or information transfer. This GPS-based location may then improve location-based services by providing real time location identification. Information about a location of an entity or asset may be referenced back to a remote reference table.

In some embodiments, the VLEC system will incorporate GPSRS technology. Currently, Internet protocol (IP) security allows an individual to access infrastructural systems from anywhere in the world. In some embodiments, the VLEC system is secure requiring appropriate passwords or necessary equipment thereby preventing ‘faking’ identities and gaining unauthorized access to IP protected systems.

In some embodiments, each control element, switch, activation device, keypad, button, dial, photodetector, LED lighting element, a dongle or key device, sensor, monitor, or other devices used to establish communication within a pulsed light communication system may include a unique location identifier 24 such as GPSRS. In some embodiments, not all of the control elements are required to include LED communication devices, and some control elements will be in direct communication with a control server 26 via wires. In alternative embodiments, a control element may be wired, where the wire extends to an intermediate pulsed light communication hub. The intermediate pulsed light communication hub may include a unique location identifier 24, controller 20, photodetector(s) 14 and LEDs and is adapted to receive pulsed light communication signals and to process the received pulsed light communication signals into electrical signals to be passed over the wire to a particular control element which may be used to change the status of another control element.

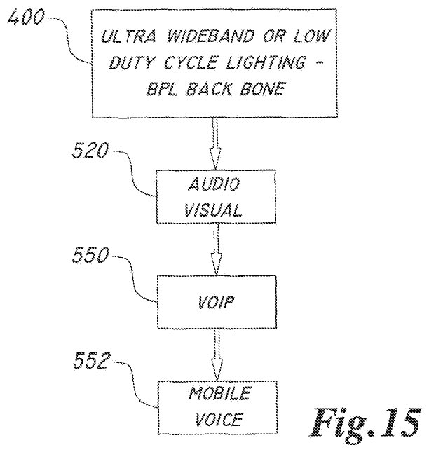

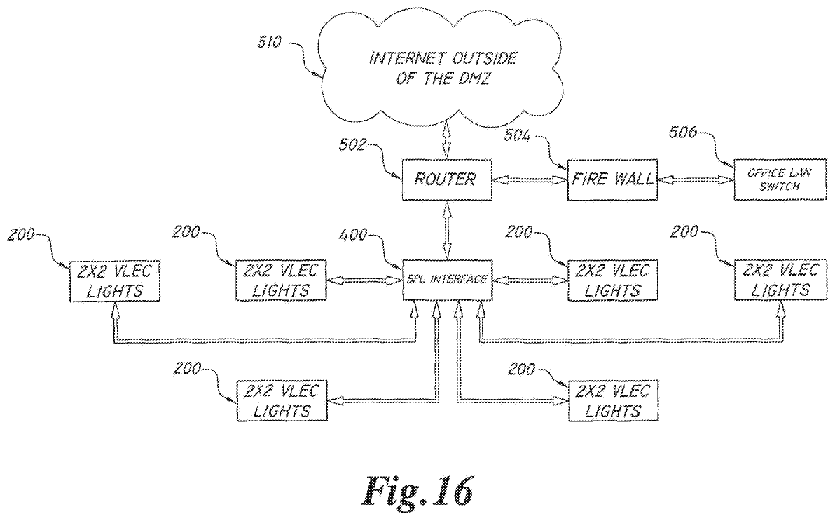

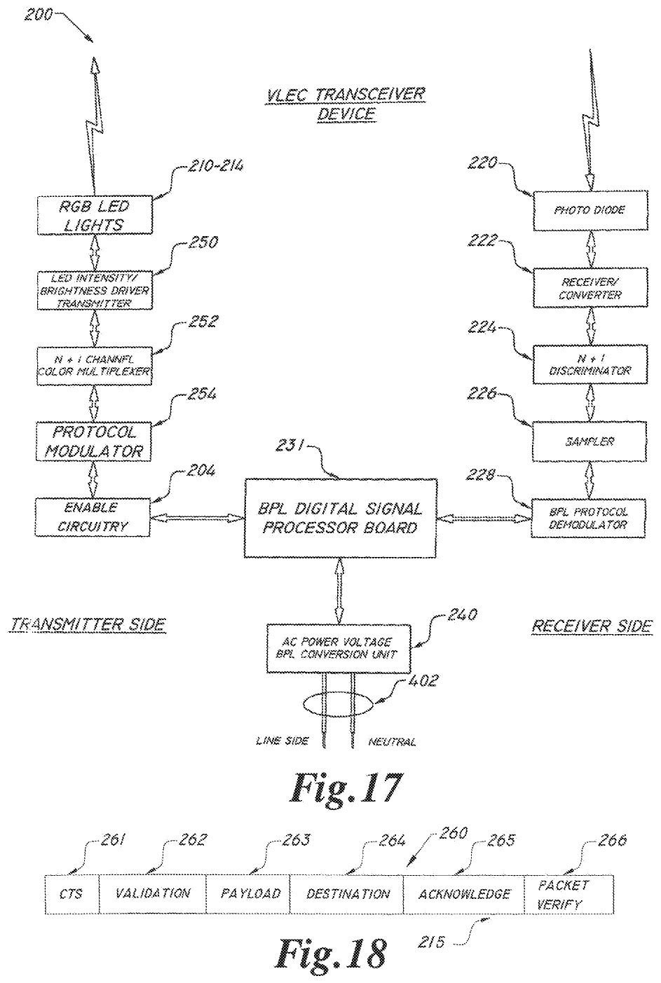

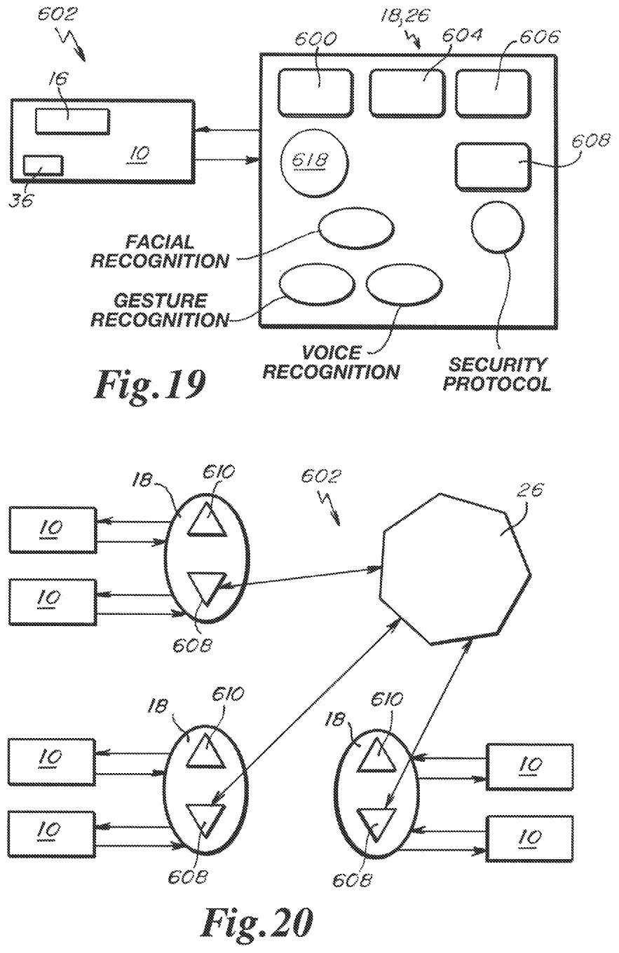

FIG. 14 illustrates many different types of exemplary communications that may be provided incorporating the VLEC technology of one embodiment of the invention. In some embodiments, an ultra wide band or low duty cycle lighting Broadband Over Power Line (hereinafter BPL) back bone is generally identified by reference numeral 400. Access to the World Wide Web will be enabled through network access 510 to allow users the benefit of web surfing. VLEC technology allows this access to be untethered and nomadic, even though beyond a building or space the network access 510 may be further coupled using conventional cable 512, Internet Service Provider (ISP) 514 links such as satellite or dial-up, DSL 516, or other suitable link 518. AV communications 520 may include various device interface applications 530 such as appliance communications or manipulation 532 and automated manufacturing 534. HDTV 540 is further contemplated, including mobile HDTV 542, mobile gaming 544 and interactive TV 546, but other types of video are additionally contemplated herein, including Slow-Scan TV (SSTV) or other known systems for capturing video information. Telecommunications and personal communications may further be enabled, for exemplary purposes using Voice Over Internet Protocol (VOIP) 550 and mobile voice 552. Other A/V applications are generically identified at 560. In another contemplated communications category, tracking data 570 may be gathered and used based upon the unique addresses assigned to VLEC host fixtures. The tracking information may be used for energy management 572, Global Positioning Satellite Routing Systems (GPSRS) 574, security 576, and other tracking applications 578. While communications are conceived as occurring between a plurality of hosts and clients simultaneously, in many instances one client will only be coupling one data stream at a time with a host. To better illustrate this, FIGS. 15-17 illustrate examples of single data category exchanges that might occur between a host and client.

In one embodiment, FIG. 18 illustrates one possible configuration of network related components in combination with one possible configuration of VLEC related components. As illustrated therein, the Internet 510 may be accessed through a router 502, which might, for exemplary purposes, be coupled through a hardware or software firewall 504 to a standard office LAN and switch 506. While not illustrated, firewall 504 may also optionally be provided between router 502 and BPL interface 400. From BPL interface 400, a plurality of VLEC hosts 200 may be provided, each directly coupled to BPL interface 400. In some embodiments, directly wiring each VLEC host 200 to BPL interface 400 may occur, but where desirable providing wireless VLEC communications between VLEC hosts 200 may occur, such that a communication from a client may pass through one or more optical-to-optical links before being coupled into a wired link.

In some embodiments, the use BPL by the VLEC system may enable more advanced telecommunication and broadband services. For example, the hurdles of the “Last Mile” could potentially be avoided by transmitting data signals over a utility company's infrastructure in tandem with existing fiber optic network transport. Combined with the internal distribution of VLEC light fixtures throughout a building, the VLEC system may provide unlimited data hot spots without the latency caused by traditional physical limitations. Within a ubiquitous network environment using a VLEC system, customers may enjoy higher data speeds and security throughout an entire facility.

In some embodiments, cameras and other integrated devices may be used as environment sensors, detecting human traffic or ambient light, such as sunlight. In some embodiments, the camera, microphone, speaker and/or sensory equipment may reduce lighting energy consumption when a room is unoccupied or when ambient light conditions allow for reduced indoor lighting intensity.

In some embodiments, the VLEC system may include other biometric recognition software such as voice recognition software, retinal scanner software, finger print or other digit or palm recognition software to name a few.

In some embodiments, as a packet of information travels from its source destination to its final destination, it is continually evaluated by each communication node (VLEC light fixture or other GPSRS enabled network device) through which it passes. Each communication node interrogates the packet of information to discover the packet's last known destinations and its intended final destination, and checks that information against its current location and intended subsequent location to determine if any discrepancies exist. In addition, each communication node interrogates the packet of information to discover the time of the transmission and/or receipt from the packet's last known destinations to verify or determine if any timing or delay discrepancies exist during the communication or over the communication route. Each data packet is therefore subjected to continual and ongoing authentication by each communication node (VLEC light fixture or other GPSRS enabled network device) through which it passes. If no discrepancies are identified then the packet is tagged with unique identifier information from the interrogating communication node and sent to the next node along its path, where it is again evaluated using the information from the previous node and those preceding it. If a discrepancy exists, the packet cannot proceed within the VLEC system. This procedure establishes security for the data packet in real time and real space.

In one embodiment the VLEC system has the capacity to provide low power communications for energy management, emergency back-up, security and special applications utilizing alternative power sources such as batteries or solar cells. Since each individual LED light panel may be separately controlled, unnecessary lights may be extinguished in an emergency or during periods of nonuse. In some embodiments, the remaining lights may also or alternatively be used to maintain nominal communications channels within a building. The signals in such instance may be unable to be carried through power lines, and so may alternatively be implemented through an optical-to-optical repeater function from one light to the next, to travel entirely through a chain of LED light panels.

A Digital Signal Processor or the like 231 may be provided for program control that can transmit/receive data to/from BPL communication network through transceiver 200. The Digital Signal Processor 231 in an embodiment may respond to commands received on a network through S-BPL coupling 240 to manipulate enable circuitry 204, and may also issue commands or send data to network if needed. If the transmit portion of enable circuitry 204 is enabled, these commands/data will also be passed to the optical link.

Enable circuitry 204, may in one embodiment be enabled to turn on or off the LED optical transmitter 250, as well as change the characteristics of the light, such as brightness and even color mix when multicolor LEDs are used. The Digital Signal Processor circuitry 231 may also manipulate the ability for BPL or any other medium transport known arts of communication network, to send and/or receive data to or from another adjacent optical link. This feature would provide the ability for the VLEC host to act as a client as well.

Driver circuitry 250 and LED(s) 210-214 will pass any signals to any optical link for other devices designed to communicate. Driver circuitry 250 may, in one embodiment, simply be appropriate buffering, isolation, modulation or amplification circuitry which will provide appropriate voltage and power to adequately drive LED emitter 210-214 into producing a visible light transmission. Exemplary of common driver circuits are operational amplifiers (Op-amps), transistor amplifiers and gates and NAND gates. Also, it is desirable to use a modulation scheme with the signal so as to provide the intended design of duality as a general lighting fixture. The transmit circuitry may have to provide a means of modulation in this case, also preferably incorporated into driver circuitry 250.

Similar to but preferably complementary with the transmission circuitry, receiver circuitry 222 receives data from the optical link detected by photo sensor 220. Receiver circuitry 222 will appropriately amplify, and may further convert a data bearing electrical signal into Binary or Digital pulses. As but one example of such conversion, demodulate circuitry 228 may additionally demodulate a data bearing electrical signal, if the data stream has been modulated by an optical host. A suitable sampling circuitry 226 and discriminator 224 will condition the data bearing electrical signal to yield appropriate and pre-determined information as a received data signal. The data bearing electrical signal is then demodulated and passed onto the DSP circuitry. From here the signal will contain protocol and payload packets that will propagate back onto the BPL Medium infrastructure.

FIG. 22 illustrates a sample data packet 260 that might for exemplary purposes be used to communicate data through a preferred VLEC apparatus. Data packet 260 might include a CTS (Clear To Send) header 261, followed by validation 262. The main data content will be carried within payload 263, followed by a destination identifier 264, acknowledge 265, and packet verify 266.

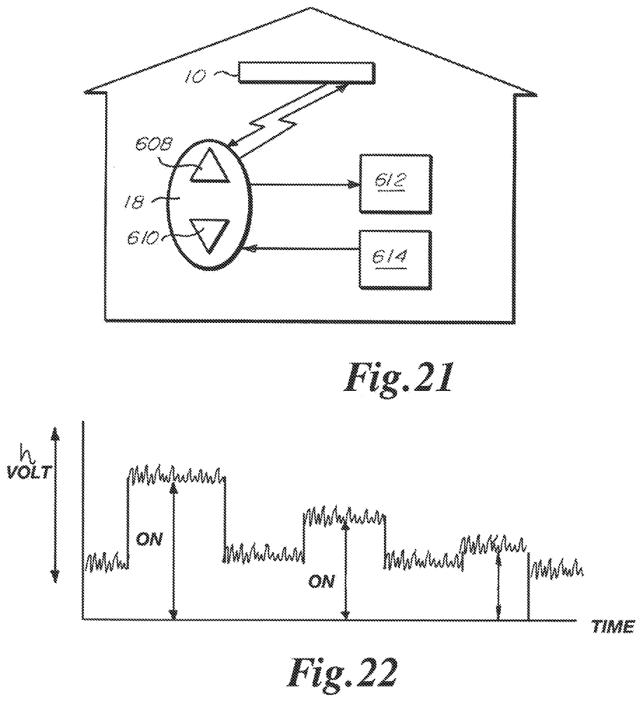

Ultra low duty cycle lighting technology can work positively by continuing to provide critical data to networks and people. With the appearance of being turned off, the lighting network can continue to communicate information. A second valuable trait is the very low energy consumption of this technology. This can be useful in a power outage, and so might preferably be implemented in combination with the apparatus of FIG. 21. The ability to communicate information in dark rooms is further beneficial as part of a energy conservation effort, since less energy is being used for illumination. Further, if the unauthorized person brings a portable illumination source such as a flashlight, optical detector 220 may detect the additional illumination and signal unauthorized presence.

While the foregoing discussions reference the illumination of a single LED or RGB LED, further contemplated herein is the separate control of a large number of LEDs. In such case, where full illumination is desired, several LEDs may be providing illumination, while other LEDs handle communication. Likewise, in the case of an ultra-low duty cycle demand, communications may be divided among a plurality of LEDs, thereby reducing the time percentage required within any individual LED, thereby permitting more data to be transferred without perceptibly increasing the illumination level from an individual LED.

Building management in accord with another embodiment of the invention further includes automated secured access control to apparatus such as doors, drawers, electronic computer operations, thermostats, and any other devices that may be electronically controlled. By means of LED communication, the location of unauthorized devices as well as persons can be tracked or polled by the LED communication system or VLEC system 602.

In some embodiments, remote access management (RAM) software 600 will allow accurate monitoring and control of individual VLEC light fixtures 10 from a centralized computing location within a VLEC system 602 equipped building. With the remote access management 600 the VLEC light fixtures 10 may be programmed to turn on/off during specific times of the day, increase/decrease in brightness or compensate for lighting conditions occurring within daylight hours. With these features, a building owner employing the VLEC system 602 may more accurately monitor and manage energy lighting consumption in a building.

In at least one embodiment, a user of a VLEC system 602 may remotely control the lighting and communication environment in a building through automated management features. For example, RAM 600 controlled VLEC lighting will have the ability to actively respond to activity within a building, such as human traffic. With daylight harvesting, RAM 600 may program VLEC light fixtures 10 to automatically reduce lumen output when sunlight is present in a room.

In some embodiments, RAM 600 will broaden the scope of VLEC system 602 services to include other security and communication features, such as centralized visual surveillance 604 incorporating security cameras 36 installed on the VLEC light fixtures 10. Incorporating intercom and facial recognition into such a VLEC system 602 may enhance security within a facility as well as providing intercom announcements directly to an individual within a VLEC system enabled environment.

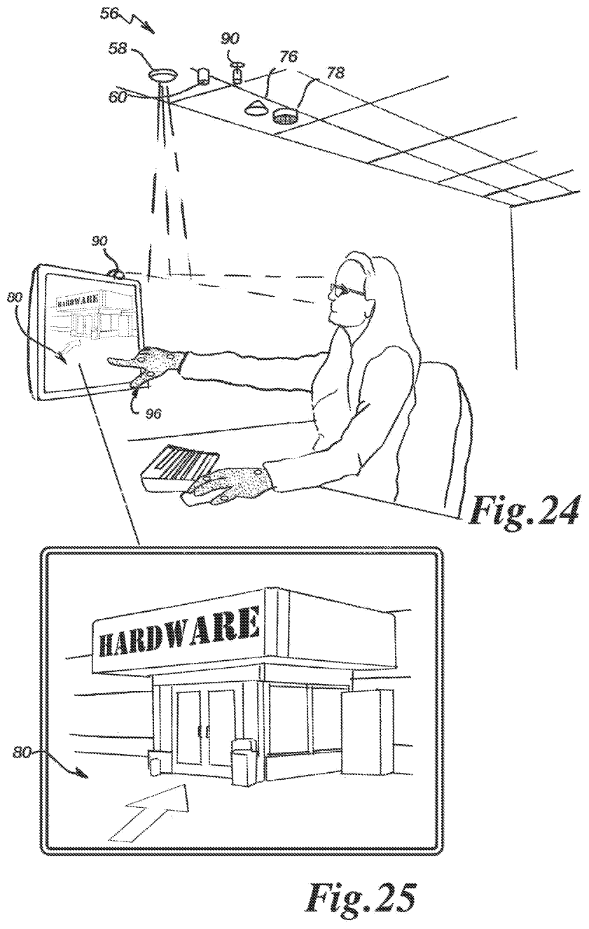

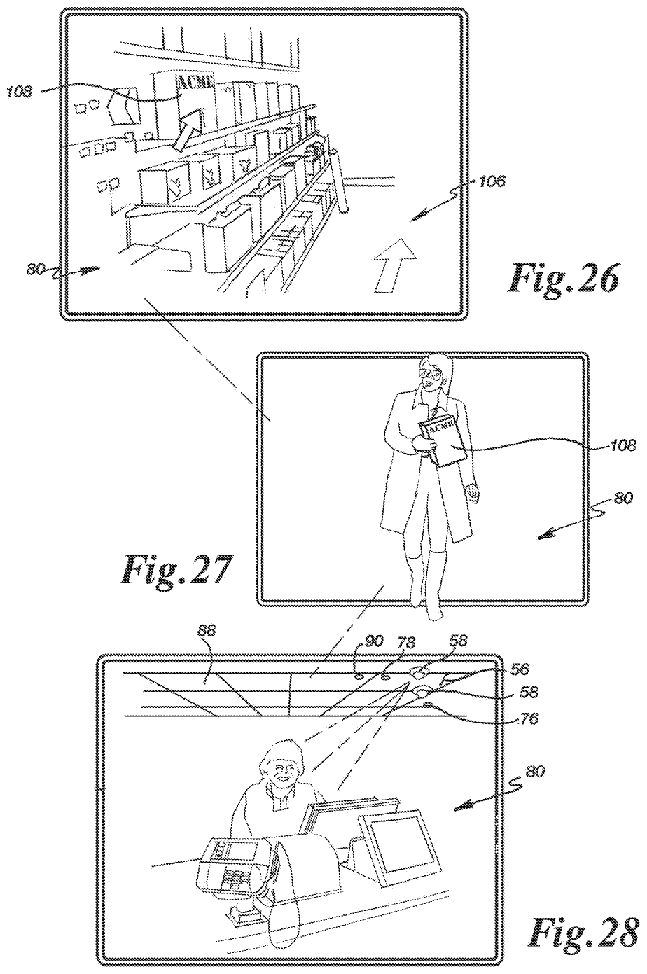

A computer located at a remote location such as a facility control unit 18 or a control server 26 may receive/record the data generated in association with the regulation and use of the LED light fixtures 10. The computer may process any number of different transactions. Any data may be retrieved for generation through a website interface 608 for transmission over a power line or through pulsed LED light communication signals via the LED/s or the USB device 12. LED pulsed light communication signals may also be transmitted out of the USB device 12 for receipt by the control unit 16 integral to an LED light fixture 10 for transmission to the facility controller 18 and/or website 608. It should be noted that a control server 26 may simultaneously receive and process data from any number of websites representative of any number of facilities or geographic areas each having any desired number of fixture controllers 42 and/or LED lights or LED light fixtures 10 (FIGS. 25 and 26).

In some embodiments, the solid state characteristics of LEDs allow enhanced control of energy consumption and light output through automated computer systems. For example, LED lights may be dimmed to provide additional energy savings. In a building incorporating a VLEC system 602, dimming may be controlled via synchronization with environmental stimuli to create a smart lighting environment which actively accounts for sunlight and saves energy by automatically dimming the LED lights within a VLEC light fixture 10 when sunlight conditions allow.

In some embodiments, VLEC lighting systems 602 may allow for further energy management for building owners as well as load management for power utilities. Power companies may have the ability to manage imperceptible reductions in lighting output across entire sections of a building, city block, or power grid. This feature would benefit the power utility and the customers, especially where peak energy consumption is high and energy demand outpaces infrastructural capacity.

In at least one embodiment, an operating exchange 610 is utilized in association with a pulsed light communication system 602, using LED pulsed light communication signals embedded within illumination generated from LED light fixtures 10. In some embodiments the operating exchange 610 is incorporated into the infrastructure of a building or structure utilizing LED light fixtures 10 and other operating systems. In some embodiments, an individual may speak any language or have any educational background or training, and the individual may be able to immediately and intuitively operate the operating exchange 610 for LED pulsed light and communication system 602 and building operative systems. In some embodiments, the operating exchange is not dependent on culture or gender training or knowledge of an individual.

In some embodiments, the operating exchange 610 is used to control all of the LED light fixtures 10 and operating parameters within a structure or building. In some embodiments, the operating exchange 610 facilitates an individual's ease of use of LED light fixtures 10 and other functions within a building. In some embodiments, the operating exchange 610 may be incorporated into more or less than all of the LED light fixtures 10 or operating systems for a building.

In some embodiments, a computer or webpage 608 on a computer may include drawings, diagrams and/or blueprints of a structure, where the operating exchange 610 permits an individual to manipulate operating systems 612 and controls 614 within a building through activation/deactivation or manipulation through the computer or webpage 608. In some embodiments, an individual may focus on a desired location on a drawing, diagram and/or blueprint in order to access a system control 614 to toggle the system control 614 to a desired setting. The desired location on the drawing, diagram, and/or blueprint may represent electronic switches and/or controls 614 for building operating systems 612. In some embodiments, the switches and/or controls 614 may communicate feedback as to the current status of a system setting. In some embodiments, the drawings, diagrams and/or blueprints as included in a computer include markers/identifiers such as rectangles or other shapes which represent LED light fixtures 10 or groups of LED light fixtures 10 or other systems 612 or system controls 614. In some embodiments, the computer may also include indicators as to operational performance such as the amount of electricity being used or the setting of a system such as operation at a maximum or high level, as opposed to operation at a low setting.

In at least one embodiment, the operating exchange 610 includes indicators as to the setting and/or operational status of building systems or features such as LED light fixtures 10, or other building operating systems 612, such as a thermostat.

In at least one embodiment, the operating exchange 610 includes indicators for LED light fixtures 10 such as the color, or color setting, for LEDs within the LED light fixtures 10. In some embodiments, the color of the LEDs within the LED light fixtures 10 may vary.

In some embodiments, each building including LED light fixtures 10 also includes a computer having a map of the location of each of the LED light fixtures 10, where each LED light fixture 10 includes a unique location identifier 24 which may have Global Positioning System Routing System information (GPSRS).

In some embodiments a controller which may be a fixture controller 42 is used in association with each individual LED light fixture 10 and in other embodiments one or more facility control units 18 are engaged to any number of fixture controllers 42. Combinations of fixture controllers 42 and facility control units 18 may be utilized in any structure and variations of configurations may be utilized dependent on installation requirements within existing structures, new construction, renovation, remolding, and/or upgrading of elderly structures.

The fixture controllers 42 include pulsed light communication LEDs and photodetectors in order to communicate the sensed status of a feature or function. The sensed status or feature may be communicated to the facility control unit 18 through the use of pulsed VLEC signals. In alternative embodiments a sensor may be integral with or in communication with the feature or function under consideration, and the feature or function may include LEDs, photodetectors, sensors and control units in order to communicate the sensed status of the feature or function directly to the facility control units 18 through the use of pulsed VLEC signals, or alternatively through one or more intermediate pulsed light communication locations or devices.

In some embodiments, the facility control unit 18 and/or each control element includes a processor, or controller which includes a security protocol to restrict activation or a change of status of a setting until such time as a security protocol has been satisfied. Any security protocol may be communicated directly through pulsed VLEC signals, or through an intermediate pulsed LED light communication hub, or via an electrical signal passed over a wire.

In some embodiments, the processor/controller 16 in communication with each fixture controller 42 receives control signals, activation signals, or change of status signals which were generated from a facility control unit 18, or other remotely located control server 26, or other system server. In some embodiments, the processor/controller 16 is in communication with each fixture controller 42 which may generate a device or operational status signal to be received by a facility control unit 18, remotely located control server 26, or other system server through the exchange of VLEC signals.

In at least one embodiment a facility control unit 18 is in communication with the LED XCVR light fixtures 10 within each facility, where the facility control unit 18 aggregates all connections from LED light fixtures 10 back through one or more power units 22 or power unit controllers 28 for communication to a control server 26 through use of the internet.

The status of a particular feature or function may be communicated to the facility control unit 18 or controller by pulsed VLEC signals from LEDs and controllers as integral to, or in communication with the features or functions under consideration. In alternative embodiments a sensor may be integral with or in communication with a feature or function under consideration. The feature or function may include LEDs, photodetectors and controllers in order to communicate the sensed status of the feature or function directly to the facility control unit 18 through the use of pulsed VLEC signals. Alternatively, the sensed status may be communicated through a fixture controller 212 or one or more intermediate pulsed light communication locations or devices, without the use of wires integral to the sensors.

In some embodiments, a room may include any number of LED light fixtures 10. Each LED light fixture 10 may be operating the same, or have a different setting resulting in a different operation.

The control server 26 may be called a facility management unit or a unit controller and comprises a computer. The control server 26 may include a web server and a website 608. The website 608 allows an individual to control the LED lights or LED light fixtures 10 and to monitor how much energy is being used. The website 608 may also regulate at least one security authorization which may be logon criteria including passwords and user verifications or other desired security measures. Following logon an individual may control the lights or other operations of a facility. An individual may use the website 608 to issue commands to the individual power units 22 in order to activate or deactivate LED lights or LED light fixtures 10 or to change the intensity or the color or the timing of the LED lights or LED light fixtures 10 to be on or off in a preset schedule or on an as needed basis.

The facility control unit 18 may also include feature program presets. The facility control unit 18 may also include image and/or sound recordings and/or camera 36. In at least one embodiment the control of facility features and functions occur over VLEC signals from LED light fixtures 10 and photodetectors which are constructed and arranged to receive, and to generate, pulsed VLEC signals.

The features or functions of the facility may include LED light fixtures 10 which may include a plurality of LEDs, and the LEDs may be individually controlled by the facility control unit 18 or controller through the interface of the facility website 608 which will communicate commands through the pulsed VLEC signals. In some embodiments the facility website 608 and facility control unit 18 or controller may communicate to an individual detailed status information and/or settings for all of the possible connected LED lights, features, and/or functions within a facility.

In at least one embodiment the website 608 includes a user interface that allows an individual to control the LED lights or LED light fixtures 10 or to activate the light switches on the wall at specific desired locations or to activate other building systems.

In one embodiment a wire may be run to specific locations within a facility where the ends of the wire include sensors to sense the current status or setting of an LED light, LED light switch, or status of a building function such as a light, thermostat, door, elevator, lock, camera, speaker, microphone, sensor or any other type of feature which may be sensed, manipulated, monitored or controlled. The sensed status is displayed on the website 608 for the facility. The facility control website 608 may include a touchscreen to monitor and to manipulate switches or to alter the status of a facility feature. The facility control website 608 facilities the selection of one or more, or all, of the features to control, and via the website, screens regulate the functions of the facility through the website interface. In certain embodiments an individual may control all lights simultaneously for both warm and cool light settings, or settings in between warm or cool, or an individual may control the warm or cool settings individually through the use of sliding features on a touchscreen, which may be used to change the intensity of the LED lights through the exchange of VLEC signals.

In some embodiments the control page of the website 608 enables an individual to establish and to set up programs for control of features and/or functions or lights for an individual room, were specific lights over a cubicle or other area are controlled remotely by the facility web site 608 and facility control unit 18 or controller through the exchange of VLEC signals.

An individual having the correct login, password and security information may access the facility webpage interface 608 from any remote location where internet access is available, in order to regulate or control the functions or features of a facility. An individual may control the lights or other functions or features with the preset settings, or the individual may selectively set the lights, function, or feature so long as the individual has an internet connection, which may be provided by a dongle or key device 12 including a photodetector and LEDs for communication through exchanged pulsed VLEC signals. In some embodiments, access to the facility webpage interface 608 may occur through the use of a desktop computing device, a transportable or laptop computing device, a cellular telephone device, a tablet computing device or any other communication device providing communication over the internet.

Logging onto the website 608 may establish access to a multi-facility management unit control page. The website interface 608 may show all of the power units 22 that are in a facility and all other LED light fixtures 10 or other features of the facility or plurality of facilities. An individual may select which power units 22 to control or an individual may select all of the power units 22 for control. An individual may alternatively activate select individual LED lights or LED light fixtures 10 to change light intensities. In at least one embodiment the website 608 includes a user interface that allows an individual to control the LED lights or LED light fixtures or to activate the light switches on the wall at specific desired locations.

In another embodiment, the website 608 will have programmed presets alternating warm light and cool light to provide a difference in the color intensity during illumination within certain locations inside or exterior to a structure at pre-selected times.

The website control interface enables control each individual light fixture 10 or LED light emitting diode. The website 608 may communicate or receive detail information to or from a power unit 22 regarding the settings and status for all of the possible connected light fixtures 10 and usage of each LED light fixture 10 or LED light emitting diode.

In some embodiments, a Power Unit Controller (PUC) is located at a data center of the facility, where an internet connection is available. If there will be more chains of power units 22 connected to the PUC than there are Ethernet ports available, then a switch may be placed between the PUC and the power units 22.

In at least one embodiment, a control server 26 will provide a means to control lighting apparatus of a facility while simultaneously enhancing and redefining security systems, facility operational systems, security cameras, public address systems as well as other systems within a building/facility.

In at least one embodiment, the control server 26 includes data tables and algorithms which process received recorded data from the fixture controllers 42 and/or the facility control units 18 which are used to generate a return signal to the facility controllers 42 and the fixture controllers 42 to adjust electrical input into the LED light sources to optimize the generation of lumens and pulsed light data communications. These communications may occur through the exchange of pulsed VLEC signals.

In at least one embodiment the stored data within the data tables and algorithms will be directed to optimization of variables as identified herein some of which being color; intensity levels, degradation as a result of time or use; historic usage as well as other variables. In addition, the control server 26 includes data tables which are used to process data and information received from the fixture controllers 42 and/or the facility control units 18.

In some embodiments, a control server 26, facility control unit 18, and/or fixture server 42 permits an individual to simultaneously engage in a plurality of activities such as internet access and use of a pulsed VLEC signal exchange, such as a video and/or verbal communications between individuals.

A control server 26 located at a remote location may include/record the data generated in association with the regulation and use of the LED light fixtures 10 through the exchange of pulsed VLEC signals. Any data may be retrieved for generation through the website interface 608 for transmission over a power line or through pulsed VLEC signals via the LED/s or the USB device 12. It should be noted that the data transfer and communications embedded within illumination may be bi-directional. It should also be noted that the control server 26 may simultaneously receive and process data from any number of websites 608 representative of any number of facilities or geographic areas each having any desired number of fixture controllers 42 and/or LED lights or LED light fixtures 10. In some embodiments, the control server 26 is a mainframe computer.

In some embodiments, the control server 26 has the capability to send a signal/instruction back (or upstream) to the controller 20 in communication with a particular light fixture 10, in order to adjust the LED light fixture 10, to alter the level of electricity to be provided to the LED light fixture 10, to modify or enhance lumen output, or regulate performance.

In at least one embodiment, in existing construction, a large centralized switch may be provided having a meter, and a plurality of sub-meters which may be electrically connected to, and in communication with, the centralized switch where each sub-meter may measure variables associated with the performance of the VLEC LED light fixture 10.

In at least one embodiment, a sub-meter is positioned proximate to an LED light fixture 10. In other embodiments, a sub-meter may be at a distance removed from an LED light fixture 10. In some embodiments, a sub-meter may be electrically connected upstream and/or downstream, from each LED light fixture 10 and either one or both of the sub-meters may be proximate to, or spatially removed from an LED light fixture 10, in any combination without restriction.

In at least one embodiment, a sub-metering function may be utilized on a per LED light basis, within each LED light fixture 10, and in other embodiments, the data collection function may be incorporated as a feature of a “smart LED” used in an LED light fixture 10. In at least one embodiment, a digital potentiometer may be used with each LED light fixture 10.

In at least one embodiment, a meter or sub-meter collects data concerning electrical consumption before and after an LED light fixture 10 in a manner similar to the measurement of electrical resistance across the LED light fixture 10, and a calculation will occur because a certain amount of electrons will be converted to photons. In other embodiments, a meter or sub-meter may include a light sensor with a meter to measure light output.

It should be noted that in some embodiments that the environment to be regulated by the controller using the facial recognition of images may include any desired configuration or combination of variables as identified herein or as available for regulation by manipulation of an electronic device 30. In some embodiments, the controller may regulate any combination of a plurality of light fixtures or LED light fixtures 10 to maximize the utility of an environment. In some embodiments, the controller using the facial recognition software may also include preset configurations for activation, deactivation, color, brightness, or dimming of illumination in any combination.

The fixture controller 42 or facility control unit 18, website 608, and/or interface enable the selection or customization of programs for individual areas or rooms, individual groups of lights or specific lights, or areas such as over a cubicle or other location.

In some embodiments, the VLEC system enhances cyber security establishing electrical smart grids, which may be based on standard Internet protocol.

In some embodiments, the VLEC system with GPSRS technology may eliminate cyber-security concerns. With GPSRS technology, a VLEC network use is tied to physical locations instead of easily manipulated passwords. Every packet of information sent over a GPSRS enabled infrastructure is tagged with a GPSRS coordinate identified with the communication node (VLEC light fixtures 10 or other GPSRS enabled network device) which may be used to access and support the network. In some embodiments, every packet of information sent over a GPSRS enabled infrastructure may also be tagged with a receipt and/or transmission time stamp by each respective communication node (VLEC light fixtures 10 or other GPSRS enabled network device) which may be used to access and support the network. Data or information to be communicated within the VLEC system will be continually tagged and/or updated with GPSRS identifiers from transmitting and receiving locations within the VLEC system. Only those packets of information tagged with the correct coordinate location (and any intermediate location along with any other necessary passwords or identifying material) have access to the system. As such, an infrastructure control may only allow access from predetermined locations (using a predetermined VLEC light fixture 10 or GPSRS enabled network device) such that the packets of information desiring access are coded with the appropriate GPSRS coordinates. In some embodiments, every VLEC light fixture 10 may be operationally tied to a GPSRS location, and will not communicate if removed from its authorized location and installed elsewhere.

In one embodiment, a location or facility providing internet access, which is concerned about security, may simultaneously provide one or more networks having different levels of security for designated areas within a structure or location, where the networks utilize optical transceivers and the exchange of pulsed VLEC signals.

In some embodiments, an indicator which may be a ring around an LED, photodetector, on a dongle device 12, or LED light fixture 10 which may emit observable light of different colors to indicate the security level or status of an area.

The recognition of the appropriate network security and the control of the indicator may be accomplished through the use of software, hardware or a combination of software and hardware which may be integral to or separated from an optical transceiver. The control unit 16 used to visually indicate what network is being utilized, and may signal attempts to gain unauthorized access to secure networks from designated low security areas.

To accomplish the provision of separate networks, a managed switch may be utilized behind or upstream from an optical transceiver so the pulsed VLEC signal becomes the link, almost similar to a wire and wall access. In this situation an area would not utilize different access couplers or jacks for every different network. Through the use of optical transceivers and through the use of one or more managed switches, only one device may be required to provide access to multiple different networks having alternative security clearances. In at least one embodiment the managed switches are capable of software switching to different networks, which in turn provides access to different levels of security.

In at least one embodiment, access to different levels having different security authorizations may occur through the use of identifiers such as a Mac code for a device. When an individual has possession of a designated client access device, which may be plugged into a computer or other electronic communication device, the designated client access device may light up and provide a pulsed LED light communication signal. In at least one embodiment the a unique Mac or other code may be recognized by the managed switch, and infrastructure behind the managed switch, to determine whether or not an individual is authorized to communicate with one or more networks or networks having different security authorization parameters.

In at least one embodiment, the control unit 16 may provide varied pulses which may be identified as sync pulses or synchronization pulses. The sync pulses retain data so that a processor integral to, or separated from, an optical transceiver may recognize and discern the data and/or the sync pulses.

In at least one embodiment the utilization of synchronization pulses may be readily recognized by the managed switch and/or processor integral or removed from an optical transceiver to either permit or restrict access to a particular network functioning in a manner similar to a master key system for a building. In some embodiments, sync pulses function as certain keys and provide access or authorization to certain networks or doors while some keys may only open a single network or door. In at least one embodiment access into a network may be regulated by a managed switch, synchronization pulses and/or from a hardware standpoint.

In some embodiments, the designated client access device may include any type of identification or authorization code which would function as a different set of signaling. The identification or authorization code used during optical communications would be unique, so that access and/or a transmission based upon an identification or authorization code for a RED network would be gibberish and unrecognizable for a GREEN network. In at least one alternative embodiment access into different network environments may be regulated by a hardware key as compared to an identification or authorization code. In at least one alternative embodiment, access into different network environments would be regulated by a combination of software incorporated into a managed switch and a hardware key. In at least one embodiment it would not be possible to access a particular network with an incorrect pulse identification which would physically prevent access to a restricted network. In at least one embodiment for the master key, one or more branches or sub keys may be available such as key “A” may have branches such as AB, AA, AC, AD, AE and underneath branches additional sub-branches may be available, so one pulse may provide authorization and/or access into one network or area, another modulation for the pulse, the timing of the pulse, or sync of the pulse may provide authorization and/or access to other networks.

In at least one embodiment the light as generated from an optical transceiver may be used as a portal for access to a managed switch 624, which in turn provides access to a designated network.

In at least one embodiment, independent variable features may be incorporated into the managed switch 624 for access to independent networks, which may also include variable capability for the timing pulses and/or sync pulses. Variations utilized in association with the timing pulses and/or sync pulses may include but are not necessarily limited to variations which are similar to AM or FM modulation communication schemes. In some embodiments the timing pulses and/or sync pulses may be, or may include, digital encryption methods or techniques. It should be noted that the types of variations to be utilized in association with the timing pulses and/or sync pulses is not restricted to the types identified herein and may include other types or variations to accomplish the desired data or other communication transfer occurring through the exchange of the pulsed VLEC signals.

In at least one embodiment the above features accomplish network differentiation or access differentiation for an individual using a network. In at least one embodiment, an individual obtains access to a network by passing a first hardware door, then the individual may obtain access to the managed switch 624 and/or the software doors prior to connection to a desired network.

In at least one embodiment, a more proficient network switch, acting as a managed switch 624, provides higher security between different networks. In at least one embodiment, a hardware door is provided in addition to a software door prior to access to a desired network thereby improving the overall security for network usage.

If the duty cycle for the LED light devices is discontinued, then the LEDs terminate communication of pulsed light signals. Varying the voltage and maintaining a duty cycle provides for the exchange of continuous communication of pulsed VLEC signals.

In at least one embodiment, the voltage provided to the LED light sources is varied and not terminated or interrupted to enable continuous and uninterrupted pulsed light communication without losing data packets, or attempting to pick up dropped communication data packets. Pulsed light communication signals are provided through a variable cycle to eliminate the necessity for digital potentiometers and extra circuitry.

The control of the diode intensity by varying the pulse width duty cycle of operation does not sacrifice communication.

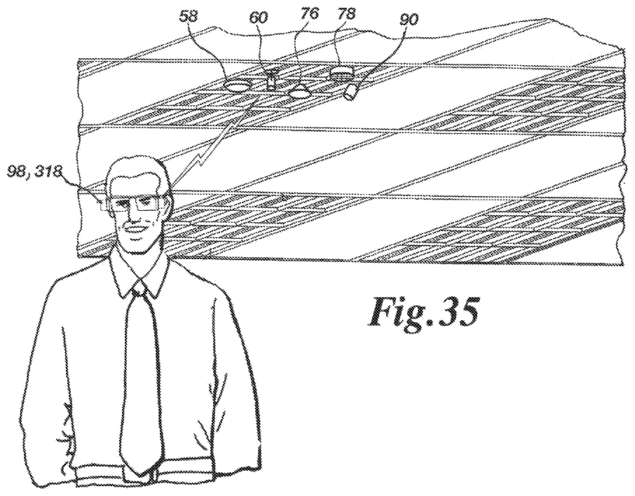

In some embodiments, having a duty cycle where power is periodically terminated to an LED light source breaks the continuous chain and flow of a communication causing pulsed light communications to fill memory for a device while waiting for power to be returned to the LEDs and for communication to resume. Because of the frequency of the flashes, continuous communication is not optimized if electricity is periodically terminated to the LEDs. Continuous communication in some embodiments may be provided by adjusting the electricity provided to the LED light sources, where electricity is continuous, yet the amount of electricity is pulsed, (variable duty cycle) where electricity is not terminated, which in turn does not interrupt a pulsed light communication signal. (FIG. 35)

In some embodiments, the voltage provided to the LEDs is varied to provide a continuous LED pulsed light communication signal. This embodiment eliminates the necessity to pick up information packets which were dropped during electrical interruption.

The present invention, in at least one embodiment, provides exchange of pulsed VLEC signals without the interruption of the communication signal by varying the duty cycle of the pulse wave form, which deviates from the duty cycle traditionally provided to the LEDs, and which does not cycle through a zero voltage or off condition.

In at least one embodiment, the invention varies the voltage to the LEDs using injector circuits having variable voltage control circuits and/or variable power supply or miniature variable power supplies. In at least one embodiment, the use of variable injector circuits having variable voltage control and/or power supply (which may be miniature) maintains the efficiencies and running the LEDs to improve the performance, quality, and operation of the exchange of the embedded VLEC signals. In at least one embodiment, the variable voltage as provided to the LEDs maximizes the efficiencies and transmission of the embedded VLEC signals while simultaneously providing a desired output of illumination. In at least one embodiment the use of variable voltage as provided to the LEDs provides or enables the embedded communication pulses to have total exclusivity to any variation in pulses. In some embodiments, power may be provided to the LEDs over the Ethernet.

In some embodiments where there is fixed voltages, improved performance may be provided through the use of variable voltages which mostly aid in communication, but also aid in efficiencies and the intensity of the light. In some embodiments variable voltages may occur over two channels over an Ethernet, so that control of the color may occur, thereby reducing the more yellow light and increasing the more white light or cool light. Warm light may also be referred to as hot and cool light may be referred to as cold. In certain embodiments it is desirable to reduce the provision of hot light, the cold light and both hot and cold light. It is desirable to not terminate or to turn the duty cycle off, so that a pulsed LED light generated communication signal may continue to be sufficiently strong, so that the signal may continue to communicate.

In at least one embodiment as shown in FIG. 35 the voltage provided to the LEDs is varied. However, the voltage is always on, and no period of time is provided in which the duty cycle or the voltage is off. As a result, data may then be embedded into a continuous or constant data stream providing a 100% bandwidth carrier. In at least one embodiment the provision of variable and continuous voltage provides higher bandwidth.

In some embodiments the provision of continuous and variable voltage provides a smoother illumination dimming capability. In at least one embodiment the LEDs operate at higher efficiency. In the traditional model an increase in the duration of off time provides less light accomplishing dimming of the illumination source. In at least one embodiment, the LEDs of the present invention are not off, and dimming occurs by a reduction in the current or voltage applied to the LEDs thereby reducing illumination and accomplishing dimming without terminating power to the LEDs.

In certain embodiments if the number of LEDs utilized on an LED light fixture 10 is increased, then the available LED diodes may be operated at a lower intensity. Due to the increased number of available LEDs in the LED light fixture 10 the overall desired light output is maintained. The running of an increased number of LEDs at a lower intensity increases the efficiency of the LEDs significantly. In at least one embodiment the amount of voltage applied to the LEDs may be varied to provide a more efficient running of the diodes which results in the efficient operation of the LEDs and the provision of a desired level of illumination.

In some embodiments, the use of a variable power supply, enables the use of two set of diodes independently. For example, channel “A” runs the warm set of diodes, and channel “B” runs the cold diodes. The hot and cold channels may then have separate voltage controls identified as injectors which may be synonymous with a variable power supply. In at least one embodiment current is injected into the LEDs and different current injectors are utilized for different channels.

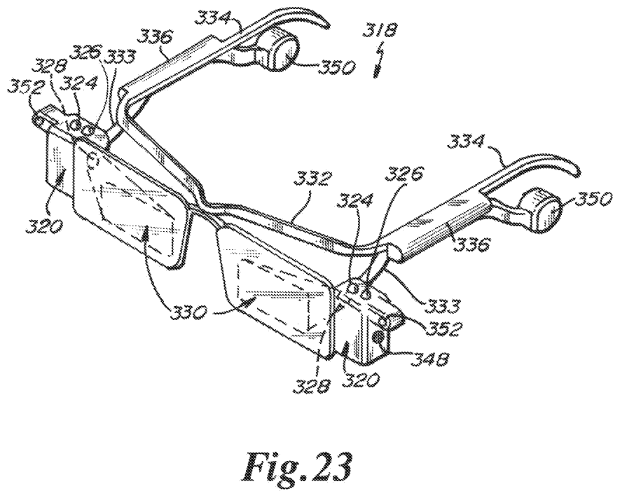

In one embodiment as depicted in FIG. 23 Visible Light Communication Transceiver Glasses are referred to generally by reference numeral 318. In this description the Visible Light Communication Transceiver Glasses 318 may also be referred to as transceiver glasses 318.

The transceiver glasses 318 may in some embodiments be formed of two lenses 330. In other embodiments the transceiver glasses 318 may be formed of a single lens 330.

In some embodiments the lenses 330 are engaged to and supported by a frame 332 which may include side supports 334 which may engage in individual's ears.

In some embodiments, on each side support 334, a battery 336 may be provided. The battery 336 may in some embodiments be rechargeable, and in other embodiments be replaceable. The battery 336 may also be integral with, or releasably attached to, side supports 334.

In some embodiments, ear speakers 350 may be engaged to frame 332 on each side support 334. Ear speakers 350 are also in electric communication with the respective battery 336 and controller/processor 320. Controller/processor 320 processes received pulsed/encrypted VLEC signals into digital signals to be generated by projector 328 onto lenses 330. Controller/processor 320 also processes received pulsed/encrypted VLEC signals into digital signals to be generated as audible communications from speakers 350. Ear speakers 350 may be constructed and arranged for positioning proximate to, or for insertion within, an individual's ear. Ear speakers 350 may also, in certain embodiments, include electrical connectors to facilitate replacement with other types of speakers 350, which may have different audible specifications and/or dimensions.

In some embodiments, frame 332 may include lower frame elements 333 which may support controller/processor 320 on frame 332. Controller/processor 320 is positioned to the outside of, and proximate to, each lens 330 of transceiver glasses 318. Each controller/processor 320 is in communication with projector 328. Each projector 328 includes a light source which generates a VLEC signal as communicated by controller/processor 320, for display of an image, text, symbol, or other communication or information on inside of lenses 330.

In some embodiments, lenses 330 are transparent permitting display images generated by controller/processor 320 to appear on lenses 330 as see-through images in a manner similar to a heads up display or HUD.

In some embodiments, lenses 330 may include desired optical coatings in order to facilitate display of images thereupon.

In some embodiments, each controller/processor 320 includes a microphone 348. Microphone 348 detects audible signals generated by an individual for processing within controller/processor 320. Controller/processor 320 may include voice recognition programming software in order to receive and execute voice commands as generated by an individual during use of the transceiver glasses 318. In some embodiments, an individual may issue a voice command as detected by microphone 348, to direct controller/processor 320 to change software applications, to search for information, to generate communications for transmission to a server optical transceiver (XCVR) as a pulsed/encrypted VLEC signal, or to change channels or power down the transceiver glasses 318. It should be noted that the above identified voice commands are provided as examples of the types of commands which controller/processor 320 may recognize for execution, and that the above identified examples are not exhaustive and/or are not limiting with respect to the types of commands and/or actions which may be taken by controller/processor 320 during use of transceiver glasses 318.

In some embodiments, at least one LED transmitter 324 and at least one photodetector receiver diode 326 are disposed proximate to, and/or on top of, controller/processor 320. Each of the LED transmitters 324 are in electrical communication with the controller/processor 320 in order to exchange pulsed/encrypted VLEC signals for transmission of information to an XCVR 116 as integral to a network plexus. The controller/processor 320 creates and regulates the duty cycle and pulsation of the LED transmitters 324, in order to transmit information which may be in the form of data packets for detection by photodetector receiver diodes integral to XCRV's 116. Communication of information and/or signals may thereby be generated by controller/processor 320 integral to transceiver glasses 318 for transfer through the network plexus for receipt at a desired location.

In some embodiments, each of the photodetector receiver diodes 326 are in electrical communication with the controller/processor 320 in order to detect and receive pulsed/encrypted VLEC signals as generated by an XCVR 116 from a network plexus. The photodetector receiver diodes 326 receive the transmissions of information via pulsed light signals from the network plexus, and electrically transfer the signals or information to the controller/processor 320 of the transceiver glasses 318, for processing. The controller/processor 320 then generates electrical signals to the projector 328 for display of images and/or information on the interior or exterior of lenses 330.

In some embodiments, a camera 352 is disposed on, engaged to, or in contact with, each controller/processor 320. Camera 352 is in electrical communication with controller/processor 320 to record images and/or video as digital signals. Images and/or video as recorded by camera 352 may be stored in memory integral to controller/processor 320, and/or may be processed for transmission as pulsed VLEC signal by LED transmitters 324 to XCVR 116 for communication to a desired location within the network plexus.

In some embodiments, camera 352 continuously records images, and in other embodiments, recording of images by camera 352 may be initiated by voice activation commands. In some embodiments, camera 352 may be similar in specifications and operation to cameras provided and available on cellular telephones.

In some embodiments, transceiver glasses 318 may include an on/off button and/or a switch which may be disposed on the bottom of one of the controller/processor 320.

In some embodiments, controller/processor 320 may include a port which is constructed and arranged for receipt of an electrical wire which is used to interface with a handheld or portable device 30. The handheld device may be used to implement commands into controller/processor 320 to provide a user with the ability to switch applications, channels, and/or functions to be performed by the transceiver glasses 318. In some embodiments, the handheld device may include a keypad and may be in the form of a personal digital assistant or tablet type of device.

In some embodiments, the elements of the LED transmitters 324 and/or the photodetector receiver diodes 326 may be disposed at other locations about the controller/processor 320. In some embodiments, the handheld device 30 may include LED transmitters and/or photodetector receiver diodes where upon the handheld device 30 and the transceiver glasses 318 may communicate through the transmission and receipt of pulsed/encrypted VLEC signals. Commands as related to applications, channels, and/or functions may thereby be transmitted by handheld device to controller/processor 320 for operation of transceiver glasses 318.

In some embodiments, the projector 328 may display two images simultaneously, one for each eye of the user of the transceiver glasses 318. The correct alignment of the images on the lenses 330 of the transceiver glasses 318 assist a user's brain to form a composite image from the two images, providing a sense of depth in the formation of a 3-D image.

In some embodiments, the transceiver glasses 318 are binocular or bi-ocular. In some embodiments binocular display on the transceiver glasses 318 will create two slightly different images one to each eye, where bi-ocular displays project one image that is visualized simultaneously by both eyes. At least one embodiment, a combination of binocular and bi-ocular images may be used in association with the transceiver glasses 318. In some embodiments, the transceiver glasses 318 may also display images so that a user feels immersed into the display. In at least one embodiment, the transceiver glasses 318 are non-immersion enabling a user to at least partially see adjacent surroundings.

As disclosed herein the term “photodetector” includes “photodiodes” and all other devices capable of converting light into current or voltage. The terms photodetector and photodiode are used interchangeably herein. The use of the term photodiode is not intended to restrict embodiments of the invention from using alternative photodetectors that are not specifically mentioned herein.

The use of pulsed VLEC signals as the communications channel between a set of Visible Light Communication Transceiver Glasses 318 and host, offers an advantage in security, reliability, system testing and configuration, bandwidth, infrastructure, and in other ways. Security is greatly increased because pulsed VLEC signals do not go through walls, in contrast to radio communications, and steps can be taken to obstruct visible transmissions with a much greater certainty than with high frequency radio waves. Furthermore, the pulsed VLEC signals may additionally be limited or directed by known optical components such as lenses and reflectors to selectively form beams, as opposed to omnidirectional transmissions.

In at least one embodiment a host LED fixture system or a stationary LED lighting fixture may be used in order to communicate data. Inside of LED lights there may be one or many diodes; these may pulsate on slightly different frequencies from a single light to communicate. Each may be looking for changes by way of Multiple Channel Access or other suitable technique.

When a client using a set of Visible Light Communication Transceiver Glasses 318 inputs or initiates a request for channels, the host may respond with the location of the channels. LED lights 324 in a ceiling, for example, will communicate with any capable transceiver. One suitable method may use BPL (Broadband over Power Lines) for network connection, taking data and embedding the data into a carrier frequency or group, but instead using power lines or wave guides for transmission throughout an existing set of power lines within a building. Thus, a building may be wired only for lights, utilizing an existing infrastructure.

In at least one embodiment, a set of Visible Light Communication Transceiver Glasses 318 provides Internet access to a customer. The customer's transceiver glasses 318 may be in operative communication with a power line bridge. The power line bridge may modulate the signal sent via a street light or other LED light source and inject the modulated signal onto electrical wiring, for reception by the photodetectors 326 integral to the Visible Light Communication Transceiver Glasses 318. In at least one embodiment, the modulated signal is injected onto the electrical wiring at the electrical mains feed at the circuit breaker panel. This embodiment may inject the signal to all electrical circuits at a designated location, providing access to the signal on each electrical circuit in the location. In some embodiments, rather than injecting onto the electrical wiring at the electrical mains feed at the circuit breaker panel, the modulated signal can be injected onto specific electrical circuits, if desired.

In some embodiments the main light source in the room doubles as an optical link for the Visible Light Communication Transceiver Glasses 318. Because the optical XCVRs 116 are located in the ceiling, there are few items that can block the light signal to the transceiver glasses 318.

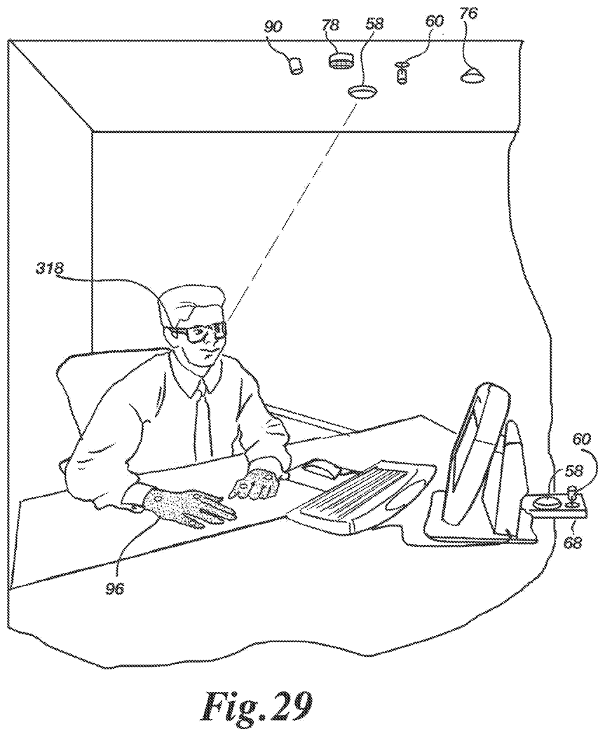

In another embodiment of the invention, Visible Light Communication Transceiver Glasses 318 and/or user interface devices may include optical XCVRs 116, as shown in FIG. 29. The photodetector receiver, and LED transmitters of a set of transceiver glasses 318 communicates with the optical XCVRs 116 that are also acting as room lighting, hall lighting, or other lighting in a customer's facility.

Visible Light Communication Transceiver Glasses 318 may also include features commonly found in standard security identification badges, including but not limited to such attributes as anti-counterfeiting features for an assigned indicia such as employee identification number, or name. An embedded non-alterable electronic, visible, sonic or other identification code may also be provided in Visible Light Communication Transceiver Glasses 318.

Some embodiments of the transceiver glasses 318 include any, all, or any combination of the following devices: a microphone 348, ear speaker 350, a rechargeable battery 336, and a video camera 352. In at least one embodiment, the microphone 348 is in communication with an analog-to-digital converter (ADC)(not shown) for converting the analog speech input to a digital signal. An amplifier circuit can be used to boost the microphone signal. The signal can be amplified prior to or after the ADC. In some embodiments, the speakers 350 are in communication with a digital-to-analog converter (DAC)(not shown) for converting the received digital signal to an analog output. An amplifier circuit can be used to boost the speaker signal. The signal can be amplified prior to or after the DAC. The processor 320 may convert the digital signals from the microphone/amplifier to data packets that can be used for transmission by the optical XCVR 116. Similarly, the processor 320 may convert the data packets received by the optical XCVR 116 to audio out signals directed to the transceiver glasses 318 and speakers 350. The processor 320 can convert data packets received from or directed to the video camera 352.

In such an embodiment, the user may use the transceiver glasses 318 as a communication and/or recording device. Alternatively, the user may use the transceiver glasses 318 to stream music, or video. Furthermore, the optical XCVR 116 and/or the transceiver glasses 318 may also include non-volatile memory (FLASHRAM, EEPROM, and EPROM, for example) that can store firmware, as well as text information, audio signals, video signals, contact information for other users, etc.

The optical XCVR 116 and transceiver glasses 318 may each include one or more photodetector receiver diodes 326 for receiving transmitted VLEC or other light signals, and one or more LEDs 324 for transmitting LED signals. In some embodiments, an optical signal amplifier is in communication with the photodetector receiver diodes 326 to increase the signal strength of the received light signals. In at least one embodiment, the LEDs 324 are in operative communication with an LED power driver, ensuring a constant current source for the LEDs.

In at least one embodiment, the transceiver glasses 318 are embedded with a unique identifier 24. The transceiver glasses 318 broadcasts the unique identifier 24 at regular intervals, or irregular intervals if desired. Optical XCVRs 116 located within the user's building and near the user can then receive the unique identifier 24 transmitted by the transceiver glasses 318.

In some embodiments, an optical XCVR 116 may be engaged to a door lock. When a user with a set of transceiver glasses 318 approaches a locked door, the transceiver glasses 318 broadcast a unique code, and an optical XCVR 116 in communication with the door lock which receives the code, and if acceptable, unlocks or opens the door. A table of acceptable codes may be stored in a memory device that is in communication with, and accessible by the door's optical XCVR 116. Alternatively, the door's optical XCVR 116 may transmit a code to a central station that compares the user's code against a table of approved codes and then sends a response either allowing or denying access.

In at least one embodiment, the transceiver glasses 318 may be used in conjunction with the LED lighting in hallways, rooms, etc. to reduce energy consumption. For example, all the lights in a hallway may have a standby setting such that they are relatively dim or even off. As a person with a set of transceiver glasses 318 proceeds down a hallway, the lights in front of the person turn on in response to a transmitted signal. As the person moves beyond a light, the light returns to its standby setting of dim/off brightness through a signal communicated from a XCVR 116 at a sufficiently remote location to indicate that the individual has passed, and is no longer present at this particular location. The presence of an individual proximate to an XCVR 116 may be determined by either recognition of a signal, or through the failure to continue to recognize a signal, or by a proximity calculation as based on a controller receiving a signal from a remote location, which indicates recognition of a transceiver glasses 318. A proximity may then be calculated where initial or previous XCVR light sources are extinguished as an individual passes a particular location. In other embodiments, the LED lights can gradually become brighter, as a percentage of full brightness, as a person approaches, and then gradually dim, as a percentage of full brightness, as a person moves away based on proximity calculation as earlier described.

The XCVR's 116, in accordance with an embodiment of the invention, may have AC wiring with data carriers such as S-BPL, and static locations encoded into the system. Thus a person entering a hallway with a set of transceiver glasses 318 could use only those lights needed for his travel. As the person progresses toward a destination, the lights behind the person may be no longer needed and so may be programmed to turn off. These lights could function variably from 10% to 100% brightness as needed, for example. In at least one embodiment when a person has traveled, lights may be extinguished, in effect providing a moving “bubble” of illumination surrounding person wearing a set of transceiver glasses 318.

In at least one embodiment of the present invention, extent of human interaction required to control various functions such as light switches and thermostats, is reduced while simultaneously increasing the capabilities of such controls. Individual or selected groups of lights may be selectively configured for optimal physiological and psychological effects and benefits for one or more applications. Individual or groups of LED lights may be readily reconfigured without changes to physical structures for diverse applications having different requirements. Such embodiments are an improvement over conventional motion detectors, due to the “smart” nature of the optical XCVRs 116 as integrated for communication with transceiver glasses 318.

In at least one embodiment, if audio and/or video is enabled by a user, video of the transceiver glasses 318 may be used to capture the last-known conditions of a user or an area. In at least one embodiment, the transceiver glasses 318 may be in communication with an intelligent audio/visual observation and identification database system which may be coupled to sensors as disposed about a building. The combined system may then build a database with respect to sensors within specific locations, pressure sensors, motion detectors, communications between, and locations of, transceiver glasses 318. Recorded data as received from various sensors may be used to build a database for normal parameters and environmental conditions for specific zones of a structure for individual periods of time and dates. A computer may continuously receive readings/data from remote sensors and/or transceiver glasses 318 for comparison to the pre-stored or learned data, to identify discrepancies therebetween. In addition, filtering, flagging and threshold procedures may be implemented to indicate a threshold discrepancy, which may in turn initiate an investigation. The reassignment of priorities, and the storage and recognition of the assigned priorities, may occur at a computer to automatically recalibrate the assignment of points or flags for a threshold discrepancy.

GPS systems and cell phone triangulation techniques are typically only accurate to one or several hundred feet. Horizontally, this precision is adequate for many applications. However, vertically several hundred feet could encompass twenty floors in an office or apartment building. In at least one embodiment the transceiver glasses 318 are in communication with the network plexus and are capable of GPS precision to a room or light fixture, improving GPS accuracy. The use of the transceiver glasses 318 in association with the network plexus can locate a person immediately, even in a large area and/or among a large crowd, and can keep track of a large population simultaneously. As noted, the large bandwidth permits video signals to be integrated with transceiver glasses 318 location and movement, providing the opportunity to create audio-video records that are fixed in time and location.

Since location may be relatively precisely discerned, optical transmitter or LEDs may in one embodiment be integrated with projector 328 to display colors, flash, or otherwise generate a visible or audible signal to assist with directional guidance, personnel or intruder identification, energy management, or to facilitate the meeting and connection of individuals.

In some embodiments a data packet 215 may include GPS location header bits that include the packet's destination address 264 in GPS coordinates. The data packet 215 may further include GPS location trailer bits that include the packet's origin address in GPS coordinates. The data packet may further include the address in GPS coordinates of the overhead optical XCVR that most recently transmitted the packet 215 (the last known transmission address, or LTA), as will be described in more detail below. The data packet further includes the data to be transmitted, and may include any other bits of information determined to be necessary for successful transmission of data, such as error detection bits. (FIGS. 9 and 18)

Routing data packets from one location to another location can be accomplished using GPS location information tags or data packets having a geographic location instead of a cyber location. Such an embodiment eliminates the need for any later geographic location translation because a data packet starts with geographic source and destination information.

In some embodiments, each data packet 215 is assigned a GPS origin/destination address as it passes through the network infrastructure. The data packet 215 is always searching for the next closest GPS address location. Each stationary (or static) optical XCVR 116, and some dynamic optical XCVRs, within a network will be designated with a GPS location number.

As a data packet 215 passes through the network, it is routed by the optical XCVRs, 116 with their internal processors, to the next physically closer optical XCVR 116 within the network. If another optical XCVR is within receiving range, or is connected with another form of communication medium, that optical XCVR 116 receives the data packet 215. The optical XCVR's 116 internal processor compares its internal GPS location address (ILA) to the data packet's GPS destination address 246 and the optical XCVR's last known transmission address (LTA) stored within the data packet 215 as originating from the individual transceiver glasses 318. If the code is closer to the data packet destination address 246 than the LTA code stored within the data packet 215, the optical XCVR's processor inserts its internal location address code into the data packet 215 as the new LTA code and then repeats transmission of the entire data packet 215 with the updated LTA code.

The network continues this process until the data packet 215 reaches the destination optical XCVR 116 which then transmits the data packet 215 to a pair of transceiver glasses 318, at which point the data packet 215 is projected or otherwise communicated to an individual. If a piece of the infrastructure is missing, the data packet 215 will be rerouted to the next nearest optical XCVR 116 and continue until it finds the shortest pathway through the network to the destination address 246.

Furthermore, the data may be communicated in a mesh-fashion, where each XCVR lamp directly communicates with adjacent XCVR lamps and does not require central communications or processing. As a result, with little if any infrastructure required, other than visible light encapsulated communication illumination and appropriate processors and programming for each XCVR lamp, signals may be quickly and directly routed from origin to destination.

This means that each user on the network may declare one or more static positions and also may have a dynamic position. A static address may be a home, an office, etc. When a user leaves their static address location to move through the network infrastructure, the user then becomes dynamic. The network may track the user as the user passes optical XCVRs 116, and provide a dynamic address location. If a data packet 215 begins with a destination address 246 that is the user's static address, the network may update the packet with the user's new dynamic address and reroute the packet accordingly.

In one embodiment the system controller/processor server 26 will continuously record and store in real time the received pulsed light communication signals for individual transceiver glasses 318 in one or more system databases, one or more subsystem databases, or individuals specific databases, in order to assist in the establishment of normal routine parameters for designated locations or areas within a facility.

Depending upon the communications channel, in some embodiments a variety of client connection devices, such as transceiver glasses 318, may be in communication with other transceiver glasses 318 utilizing PCMCIA or PC cards, serial ports, parallel ports, SIM cards, USB connectors, Ethernet cards or connectors, firewire interfaces, Bluetooth compatible devices, infrared/IrDA devices, and other known or similar components.

Driver circuitry and LEDs may pass any signals to the optical link for other devices designed to communicate with transceiver glasses 318. Driver circuitry may, in some embodiments, provide appropriate buffering, isolation, modulation or amplification, which will provide appropriate voltage and power to adequately drive LED emitter into producing a visible light transmission. Exemplary of common driver circuits may be operational amplifiers (Op-amps) and transistor amplifiers.

In some embodiments, access to a BPL or Broadband over power line system, data is carried as a signal through existing mediums like fiber-optic cable, radio waves, conventional telephone lines, or through the Visible Light Embedded Communications (VLEC) around high-voltage lines. It is then injected into the power grid downstream, onto medium or low voltage wires to businesses and homes. Customers may then gain access via a VLEC source and ferry the data back and forth to their transceiver glasses 318 through computers or through a client VLEC dongle or other appropriate adapter.

In at least one embodiment, location based services may be provided as a use of the Visible Light Communication Transceiver Glasses 318 which may have the added advantage of improved and secure content. One example is a consumer shopping mall where general consumers can walk around and discover the exact location of the goods or services they need. This is accomplished by simply providing a portal for any business to place information about their goods and services within the pulsed light plexus for receipt by a set of transceiver glasses 318. The information may also be incorporated into the BPL infrastructure by means of application controlling devices which link to the overall office or place of business to the transceiver glasses 318.

In at least one embodiment cameras 352 may be attached to the transceiver glasses 318 to aid in the facial or object recognition. In some embodiments, a plurality of cameras 352 may be oriented on a specially designed pair of transceiver glasses 318 to provide a separate controlled viewing advantage. In at least one embodiment, this would enhance the mobile peer-to-peer collaboration technology. In some embodiments users of the transceiver glasses 318 may view scenes or objects from various remote locations through the light-weight cameras 352 as attached to the transceiver glasses 318 which may provide a high definition video and high definition audio information.

In at least one embodiment, with regards to a plexus or network connectivity, a Serial, USB and 1+N-base Ethernet, or Fiber optic connection may be in communication with a host Visible Light Embedded Communications fixture system, which in turn may be in communication with a host network processor. In some embodiments the host Visible Light Embedded Communications fixture may replace conventional stationary lighting fixtures to provide optical communication between the host and transceiver glasses 318. In some embodiments, the host VLEC light fixture may be preferably constructed and arranged to communicate data through pulsed light transmissions.

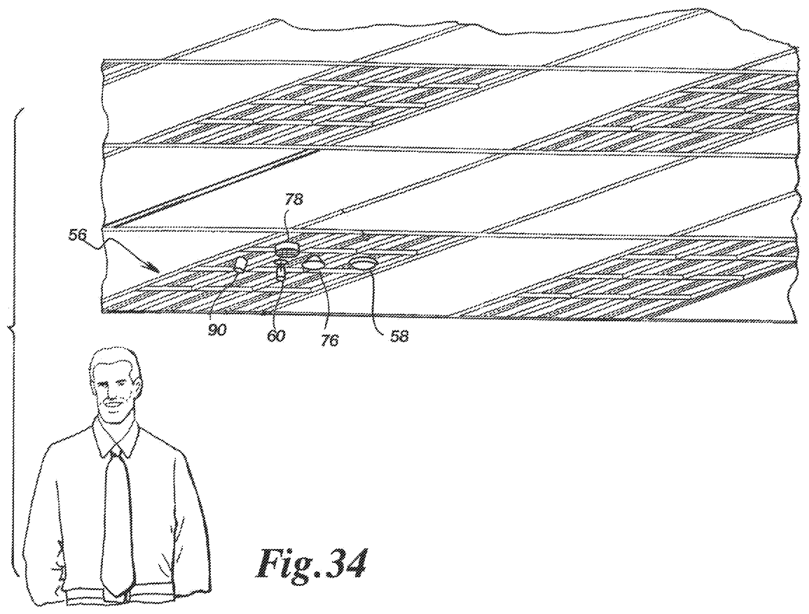

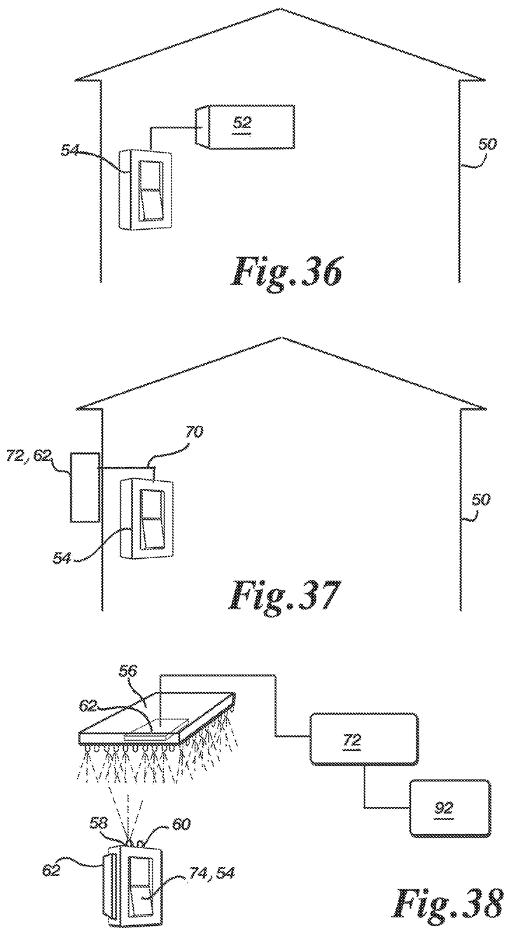

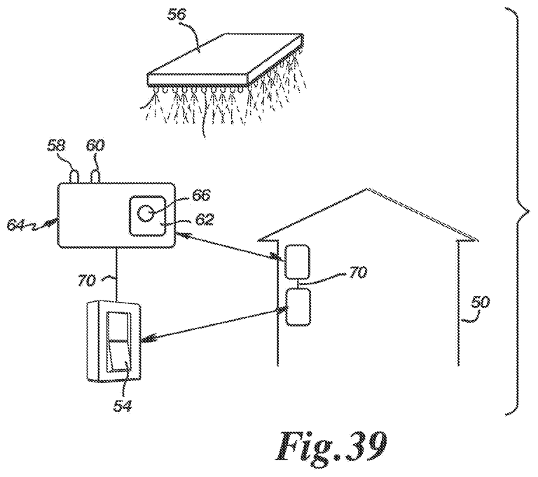

In some embodiments, a building, structure or facility 50, includes a plurality of building operating systems 52, example of which include but are not necessarily limited to light systems, intercom or public address systems, fire alarm systems, HVAC systems, elevator control systems, security systems, and plumbing systems to name a few. In some embodiments, each building operating system 52 may include a building operating system control item 54 which may be used to control or regulate the applicable building operating system 52. (FIGS. 24-39)

In some embodiments, building operating system control items 54 are centrally located and in other embodiments the building operating system control items 54 are located adjacent to the respective building operating system 52. In some embodiments one or more building operating system control items 54 may be electrically connected and in communication with a facility computer/server/controller through the use of wires 70.

In alternative embodiments, a building structure or facility 50 may include a plurality of LED light fixtures 56, where each LED light fixture 56 is constructed and arranged and/or adjusted to engage in visible light embedded communication activities to provide visible light communication.

In some embodiments, one or more building operating control items 54 include or are connected to a light emitting diode 58, photodetector or photodiode 60, and/or a controller 62, in any combination. The building operating control items 54 may also be connected, coupled or engaged to switches, motors, valves, or the mechanical or electrical devices which may be operated by electrical signals to change the status and/or the setting of a building operating system control item 54.

In some embodiments, not all of the control items 54 are required to include LED communication devices, and some control items 54 will be in direct communication with a building operating system 52 via wires 70. In alternative embodiments, a control item 54 may be wired, where the wire extends to an intermediate pulsed light communication hub 64. The intermediate pulsed light communication hub 64 includes a unique location identifier 66, controller 62, photodetector(s) 60 and LEDs 58 and is adapted to receive pulsed VLEC signals. The controller 62 of the pulsed light communication hub 64 processes received pulsed VLEC signals for conversion into electrical signals, to be passed over the wire 70 to a particular control item 54, to change the status of the control item 54 and building operating system 52.

In some embodiments, each LED light fixture 56, LED dongle device 68, and each control item 54 includes processors/controllers 62, LEDs 58, and photodetectors 60 to generate and/or receive visible light embedded communications within a pulsed light communication system. The embedded VLEC signals may communicate information as to the status of a LED light fixture 56, dongle 68 or control item 54. In some embodiments, each control item 54 of a building operating system 52 has an integral LED photodetector 60 and/or controller 62 and LEDs 58 for embedded VLEC communications. Alternatively an operating system 52 or control item 54 may be retro-fitted to include an LED communication device such as a dongle device 68 to receive pulsed VLEC signals from an LED light fixture 56, and to generate and communicate embedded pulsed LED light signals for receipt by an LED light fixture 56 to provide information in response to a status inquiry.

Each building operating system 52 may receive command signals through receipt of pulsed VLEC signals. Each building system 52 may also transmit a current status through the pulsed VLEC signals. Each system control item 54 may be used to initiate the transmission of a command signal through a pulsed VLEC signal.

In some embodiments, each control item 54 may include sensors, meters, controllers/processors 62, photodetectors 60, and LEDs 58 to receive and to generate embedded VLEC signals to a facility control unit 70. In some embodiments, each control item 54 may be electrically connected to, and in communication with, motors, devices, servo motors, valves solenoids, or other mechanical or electronic devices which are used to alter the status of a building operating system 52 or control item 54 such as a door lock, a thermostat, a light switch 74, an elevator control, a speaker 76, a microphone 78 and/or a monitor to name a few. It should be noted that the identified elements for the control items 54, building operating systems 52, system elements, or other identifiers herein are not intended to be exhaustive, and should be interpreted as expansive and are not intended to be limiting as to the specific elements or types of elements as identified herein.

In some embodiments, the facility control unit 72 and/or each control item 54 includes a processor/controller 62 which includes a security protocol to restrict activation or a change of status until such time as the security protocol has been satisfied. A security protocol may be communicated directly through embedded VLEC signals or through an intermediate embedded pulsed LED light communication hub 64, or via an electrical signal passed over a wire 70. In some embodiments a change of status for a higher security clearance control item 54 will require additional security verification or security protocols as included with a pulsed VLEC signal and will automatically generate a security communication to a remote server 92 or facility control unit 72 as a security warning to another individual.

In some embodiments, the processor/controller 62 in communication with each control item 54 receives control signals, activation signals, or change of status signals which were generated from a facility control unit 72, or other remotely located control server 92, or other system server.

In other embodiments, functions such as microphones 78 and speakers 76 may be regulated if equipped with an embedded pulsed light communication interface such as a dongle device 68.

In some embodiments, a facility control unit 72 and/or remote server 92 may include a or webpage. The webpage may have access to drawings, diagrams and/or blueprints of a structure 50, where an operating exchange 80 on a facility control unit 72 permits an individual to manipulate building operating systems 52 and control items 54 within a building 50. In some embodiments, the webpage functions as the interface to enable the activation/deactivation or manipulation of a building operating system 52. In some embodiments, an individual may focus on a desired location on a drawing, diagram and/or blueprint of a building 50 in order to access a building operating system control item 54 to toggle or manipulate the control item 54 to a desired setting. The drawing, diagram, and/or blueprint of the building 50 may include reference to any number of switches and/or controls for building operating systems 52.

In some embodiments, the switches and/or controls for a building operating system 52 may include sensors, meters or other electrical or mechanical setting devices to communicate feedback as to the current status of a system setting, for the building operating system 52.

In some embodiments, the drawings, diagrams and/or blueprints of a building 50 as included in a facility control unit 72 or remote server 92, may include markers/identifiers, such as rectangles or other shapes, which represent LED light fixtures 56 or groups of LED light fixtures 56 or other systems or system control items 54.

In some embodiments, the facility control unit 72 and/or remote server 92 may also include indicators as to operational performance such as the volume of electricity being used, or the setting of a building operating system 52, such as operation at a maximum level, as opposed to operation at a normal operational parameter.

The map, drawing, diagram, blueprint, two dimensional or three dimensional image of the building 50, complex or geographic area may be used as an overlay in a software application for an operating exchange 80 for a facility control unit 72 or remotely located control server 72.

In other embodiments, 3-D or laser imaging equipment may be utilized to form a virtual 3-D model for a building 50, complex or geographic area. In some embodiments, the map or virtual representation of a building 50 may include markers and images such as hallways 82, rooms 84, doorways 86, lights 88, light switches 74, thermostats, monitors, cameras 90, microphones 78, speakers 76, fire alarms, and smoke detectors, to name a few, and in doing so, form a three-dimensional walk through model for a structure 50 or other geographic area.

The 3-D representation of the building 50 may be partially transparent or a skeleton view, where elements such light fixtures 56, light switches 74, or control items 54 are visible. In other embodiments, the operating exchange 80 may assign various colors to designated portions of the virtual cyber-building. For example, hallways 82 may all be designated in a color such as beige and all of the rooms 84 may be designated by the color green.

In at least one embodiment, an operating exchange 80 is utilized in association with a visible light embedded communication system or a pulsed light communication system, using pulsed VLEC signals generated from LED light fixtures 56. In some embodiments the operating exchange 80 is incorporated into the infrastructure of a building or facility control unit 72 or remote server 92 in communication with LED light fixtures 56 and building operating systems 52. In some embodiments the operating exchange 80 includes a software operating system performing the features and functions as identified herein.

In some embodiments, the operating exchange 80 is used to control all of the LED light fixtures 56 and building operating systems 52 within a structure or building 50. In some embodiments, the operating exchange 80 may be in communication with more or less than all of the LED light fixtures 56 or operating systems 52 for a building 50.

In at least one embodiment, the operating exchange 80 includes indicators which function to communicate the setting and/or operational status of one or more building operating systems 52 such as LED light fixtures 56, or other building systems.

In at least one embodiment, the operating exchange 80 includes indicators for the color, or color setting, for light generated by the LEDs 58 within the LED light fixtures 56. In some embodiments, the color of the LEDs 58 within the LED light fixtures 56 may vary between individual and/or groups of LEDs 58 and/or other LED light fixtures 56.

In at least one embodiment, the operating exchange 80 is constructed and arranged to simulate or represent real life actions for control of a building operating system 52 in order to facilitate ease of use, and eliminate costly training and specialized education for designated individuals. In at least one embodiment, the operating exchange 80 will not utilize commands, command lines, file location, or sub-file memorization by an individual in order to control or regulate a building operating system 52.

In some embodiments, the operating exchange 80 and the virtual cyber-building may include cyber display signs and/or cyber directional markers to facilitate the recognition of a cyber-location and/or the identification of the location for a control element access panel 94 for a user within a virtual cyber-building.

In some embodiments, a cyber-sign or display may facilitate access to an instruction or to a control item 54 which is otherwise not immediately available, one example of which may be a critical function item which under normal operation is not subject to adjustment, or alternatively to a security item.

In some embodiments, an individual may use the operating exchange 80 within a virtual cyber-building to test different operating systems 52, or may adjust the status of different operating systems 52. It should also be noted that in some embodiments, the operating systems 52 may be integrated into a network, and that at least one type of backbone for a network is the embedded pulsed light communication system as described herein or as incorporated by reference.

In some embodiments, scheduling and programming of building operating systems 52 may take into consideration variables such as daylight savings time, temperature settings based on the time of year, and other variables considered during the operation of a building, the above examples not being limiting in this regard.

In some embodiments, the operating exchange 80 and an interface device 96 do not require significant training, and eliminate the need for an individual to know the location of controller commands on a computer, whether located in files or sub-files in a building operating system 52. The operating exchange 80 and the interface device 96 enable a user to engage in known life activities, such as walking to a desired location within a virtual 3-D image for a desired operating system 52 in order to implement system status modifications. For example, an individual desiring to modify the status of an elevator will virtually walk up to the elevator in a cyber-building and pull open the control element access panel 94 or port to retrieve or to manipulate a virtual control element 98 within the control element access panel 94. A command may then be processed by the operating system for the operating exchange 80 which may generate a pulsed VLEC signal from an LED light fixture 56 adjacent to a physical elevator control panel, where the pulsed VLEC signal is received by a photodetector 60 and processor/controller 62 integral, attached to, or in communication with the physical elevator controls, to modify a status setting. Alternatively, the command may be communicated by pulsed VLEC signals to an intermediate pulsed light communication hub 64 where the pulsed VLEC signal is processed, and in turn is communicated to the elevator control panel over a wire 70 to alter or modify the status of the building elevator system.

In some embodiments, the architecture of the operating exchange 80, the operating systems software, and the virtual cyber-building are sufficiently simplistic where an individual without explanation or training may modify, operate, and/or control building systems 52 through the seamless backbone of the pulsed VLEC networks or systems.

In some embodiments, the operating exchange 80 will be language neutral and include images for the virtual control elements 98, such as clocks to represent timing functions, and buttons or switches for lights, or rectangles having an image of fire for a fire alarm, to name a few of the many examples available. Therefore, in some embodiments, the operating exchange 80 is not required to be modified for use with other languages unless images or symbols are not readily recognized from a cultural perspective.

In some embodiments, each virtual control element 98, switch, activation device, keypad, button or dial, to name a few, may include a unique identifier 66. In addition, each photodetector 60, LED lighting element 56, a dongle device 68, sensor, monitor, or other devices used to establish communication within an pulsed VLEC system may include a unique identifier 66.

In some embodiments, within the virtual image of the building 50 within the software operating system of the operating exchange 80, the control element access panel 94 or port may be a virtual drawer 100 or virtual access door which when opened exposes a virtual shelf.

In some embodiments, an individual using the interface device 96 may enter the virtual building 50, walk to a designated location such as to a light switch and open a control element access panel 94 or port by sliding open a drawer 100 or opening an access door to view the virtual contents of the drawer 100 or shelf.

In some embodiments, inside the drawer 100 or on the shelf will be located a plurality of virtual control elements 98, which would appear in any shape as desired, such as a clock 102 used for setting a timing schedule to activate or deactivate the control item 54 such as a light switch 74. Another example of a virtual control element 98 could be a calendar 104 which could be used for scheduling the activation or deactivation of a control item 54 on a certain date.

In some embodiments an individual may use a central or single virtual control element 98 such as a tablet computing device to control any number of control items 54 to manipulate a setting for a building operating system 52.

In other embodiments, a single or central control element such as a cellular phone, tablet computing device, laptop computer or other portable electronic device 30 may include a dongle interface 68 for use in manipulation of the status of a virtual control element 98 or control item 54 of a building operating system 52. The dongle device 68 may communicate directly with the control item 54 through VLEC signals. Alternatively, the dongle device 68 may transmit a VLEC signal to an LED light fixture 56 which in turn may communicate the VLEC command to a photodetector 60, on or in communication with, the control item 54, to alter a building operating system 52 setting. In some embodiments, the electronic device functioning as the signal or central control element may be remotely located relative to the control item 54 and communicate a desired command to a building operating system 52 through a dongle device 68 into an LED VLEC system or network.

In other embodiments, when an individual is using the operating exchange 80 to enter a virtual cyber-building 50, an individual may grasp a virtual control element 98, such as a virtual representation of a calendar 104, and the individual may walk in the virtual cyber-building to a virtual operating system 52 such as an elevator. The operating system software will recognize the presence of the individual proximate to the elevator. The individual may then manipulate the virtual control element 98, such as the calendar 104 to adjust a setting. The operating system software of the operating exchange 80 recognizes the adjustment of a building operating system 52 and implements the authorized commands for activation of the building operating system control item 54 at the appropriate dates and/or times.

In other embodiments, the virtual control element 98 may be a universal element and may include a number of different functions such as a calendar, clock, switch, dial, and/or color palette to name a few. In this embodiment an individual may be able to virtually walk in a cyber-building 50 from one operating system 52 to another and to use the universal virtual control element 98 to alter the status and/or settings for any number of building operating systems 52.

In some embodiments, the control items 54 and/or virtual control elements 98 are restricted to operations or functions available only at a specific control element access panels 94 for a building system 52. For example control items 54 and/or virtual control elements 98 related to a control element access panel 94 or port for a light switch, would be exclusively interfaced with the building lighting system, and would not include control items 54 and/or virtual control elements 98 directed to the air circulation or air conditioning. Control items 54 and/or virtual control elements 98 for the air circulation/conditioning/cooling system would be located in a control element access panel 94 or port proximate to an air condition unit, which in the virtual 3-D image for the building 50 may be located on a roof or mechanical room or area.

In some embodiments, dependent on the building system 52 to be operated, the area or space within the control element access panel 94 will be enlarged, and the number of virtual control elements 98 accessible through the control element access panel 94 will be increased. In some embodiments, the appearance of the control items 54 and/or virtual control elements 98 is selected to as closely as possible represent the function to be regulated. A control element access panel 94 may include multiple shelves or drawers and/or virtual control elements 98 which may be placed according to an anticipated frequency of use, where certain virtual control elements 98 are located behind other virtual control elements 98 in a subordinate location. In some embodiments, a control element access panel 94 may have a restricted access indicator requiring entry of an additional security clearance prior to a status change for a building system 52.

In some embodiments the operating system software for the operating exchange 80, including the virtual 3-D image model, may be accessed by an interface device 96 which may be pulsed visible light transceiver glasses 318, virtual reality glasses, motion detectors or sensors, or manual controllers such as toggles or joy sticks, which are in communication with a display device.

In some embodiments, an individual using an interface device 96 may be required to satisfy logon, password and/or other security protocols, in order to access the building virtual 3-D image/map within the operating exchange 80. In some embodiments, a user using the interface device 96 may either remotely or virtually observe, modify, or enter into the virtual 3-D building map/model as a walk through, or may select a specific area of the virtual 3-D building map/model for observation or manipulation.

In some embodiments, an individual may use one or more interface devices 96 such as visible light transceiver glasses 318 and/or motion sensors, and may walk through a cyber-building 50, to a particular geographic location to access a virtual control element 98. Movement through the cyber-building may in some embodiments occur with body gestures, posture-recognition, eye movements, or hand movements by an individual using a motion detector/sensor device such as virtual reality gloves or hand movement sensors. In addition, in some embodiments, a user may proceed through a cyber-building by using voice commands as recognized by voice recognition software or a combination of any of the above identified interface devices, including hand controllers, joy sticks, keypad directional elements, toggles, buttons, voice commands, gestures, or movements.

In other embodiments, camera(s) 90, which may be located on an LED light fixture 56, record images for processing by the operating system software including the voice, gesture, motion recognition software feature to name a few, where the voice, gesture and/or motion by an individual functions as the interface device in substitution for glasses or sensors as mentioned herein.

In some embodiments, an individual may use an interface device 96 such as visible light transceiver glasses 318 or other interface devices 96 while present at a remote location. The individual may pass through any required security protocols to logon to an operating exchange program 80 for a facility control unit 72 having a cyber-building 3-D virtual image. The individual may then make a gesture, eye movement, posture change, head movement, voice command, or other instruction, which is detected by the visible light transceiver glasses 318, other interface device(s) 96, and/or camera 90 and is translated into pulsed VLEC signals which are communicated to an LED light fixture 56 as a portion of a pulsed VLEC system. The pulsed VLEC system may be connected to a broadband over power line system or directly to a remote control server 92. The remote control server 92 will receive the pulsed VLEC signal such as a movement command and process the pulsed VLEC signal to pass the command signal (which may occur over the internet) to the facility control unit 72 and/or the operating exchange 80 for the cyber-building. The individual using the interface device 96 may then walk through the cyber-building to a control element access panel 94 to modify the status of a virtual control element 98. Simultaneously, a reverse communication may be generated back from the operating system 52 to the facility control unit 72 (which may occur over the internet) back to the control server 92. The control server 92 then may activate an LED light fixture 56 to generate pulsed light communication signals for receipt by the visible light transceiver glasses 318 or interface device 96 for transmission onto a display as used by the operator to confirm that a status change for an operating system 52 has occurred.

In some embodiments, the use of the interface device 96 in association with the operating exchange 80 provides sensory input to an individual which in turn improves an individual's memory as to the location of virtual control elements 98 and operation of the systems 52 of a building 50. In addition, a person using the interface device 96 in association with the operating exchange 80 will know the location of control items 54 which will be proximate to the building systems 52 to be controlled or modified. The use of the interface device 96 in association with the operating exchange 80 provides a much more natural interface with the systems 52 of a building.

In some embodiments, the virtual interaction through the interface device 96 to the operating exchange 80 is designed to promote and maximize associated realities between the actual physical status of a building system 52 and the virtual cyber-building control elements 98.

In some embodiments, movement within a cyber-building may occur through body gestures, eye movements, posture recognition, voice recognition, body motion, head movements, and/or other types of recognition. The body, posture or other types of recognition may occur through the use of sensors attached to an individual. In an alternative embodiment, an LED light fixture 56 may include a camera 90 or other sensing device where the camera 90 will recognize the body, posture or other type of movement, and the controller 62 in communication with the camera 90 will convert the body, posture or other type of movement into a signal which may be passed to the operating exchange 80 for the facility control unit 72. In some embodiments, eye movements may be recognized through the use of cameras 90 or other sensors as incorporated into visible light transceiver glasses 318. The eye movement will be recorded and transmitted from the LEDs as pulsed VLEC signals from the frame of the visible light transceiver glasses 318 to at least one LED light fixture 56, where the pulsed VLEC signal will be received and processed by the controller 62, for communication to the operating exchange 80 for the cyber-building.

In an alternative embodiment, motion sensors may be incorporated into a set or pair of visible light transceiver glasses 318 which may record head or body movement. In addition, a set of visible light transceiver glasses 318 may include motion sensors and cameras 90 to recognize movement and/or sense movement or recognize or sense eye movement as commands within the operating exchange 80 for a cyber-building.

In some embodiments a camera 90 will provide a dynamic real time recognition and/or recording of an environment, individuals within an environment, or objects in an environment, for translation and incorporation into a real time cyber representation of a structure or environment.

In this embodiment, the camera 90 interfaces with the operating exchange 80 which includes a 2-D or 3-D representation of an environment, or a map to a cyber location. The camera 90 records images which are processed by the controller 62 and communicated by VLEC signals or over a Broadband over power line, to a facility control unit 72 or remote server 92. The information recorded by the camera 90 may then be matched to a previously scanned image and meshed into, or super imposed on, the previously stored 2-D or 3-D cyber representation of the environment, to provide a dynamic or real time cyber image of the individuals and objects within the environment. The operating exchange 80 and camera 90 may be used to continuously update, periodically update, or instantaneously update the previously stored 2-D or 3-D cyber representation of the environment to provide a dynamic fluid image of a cyber-environment for a user.

In some embodiments, the mapping of an environment includes the identification of objects and the positioning of objects with an environment for representation in a virtual cyber environment. This mapping may be sufficiently specific to record all objects within an environment including the identification of objects within drawers or in cabinets. In some embodiments, the camera 90 provides a dynamic or living representation of an environment, where the operating exchange 80 and the operating system software receives update images which may relocate the position of objects within the virtual cyber representation of an environment, to be consistent with the visual recordings within the subject environment.

In some embodiments, a user may use a camera 90 of an LED light fixture 56 or an interface device 96 to access the operating exchange 80 for the virtual retail cyber outlet, and may walk through the virtual retail cyber outlet using movements, posture, gestures, eye movement, head movement or other actions as earlier described. A display of the virtual retail cyber location or virtual retail cyber outlet may be displayed on an individual's computer, laptop, television, tablet, smart phone or other electronic device. An individual using an interface device 96 such as visible light transceiver glasses 318 may walk through and access the virtual retail cyber outlet in a manner as previously described as related to the control of systems of a building.

In at least one embodiment as may be seen in FIG. 24 an individual is wearing a user interface device 96 such as visible light transceiver glasses 318 and motion sensitive gloves. The individual in FIG. 24 is accessing the operating exchange 80 through the user interface devices 96. In FIG. 25 the individual is moving to enter into a premise site for a virtual retail cyber location such as a hardware store having LED pulsed light fixtures 56 and VLEC capabilities. As may be seen in FIG. 26 the individual in the virtual retail cyber location is walking down an isle 106 browsing for desired goods. In FIG. 27 the individual has retrieved an item 108 and has moved in the virtual cyber location to present the item 108 to a customer service employee for purchase as depicted in FIG. 28. In FIG. 28 the customer service employee is in communication with the individual in real time through the use of VLEC signals to complete a transaction as earlier described.

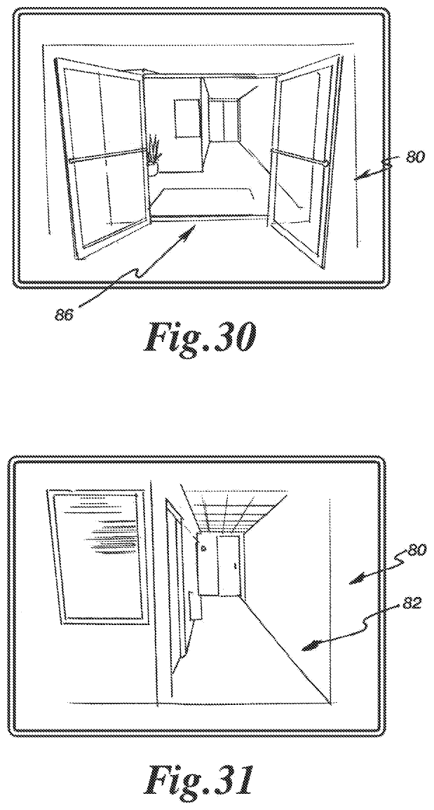

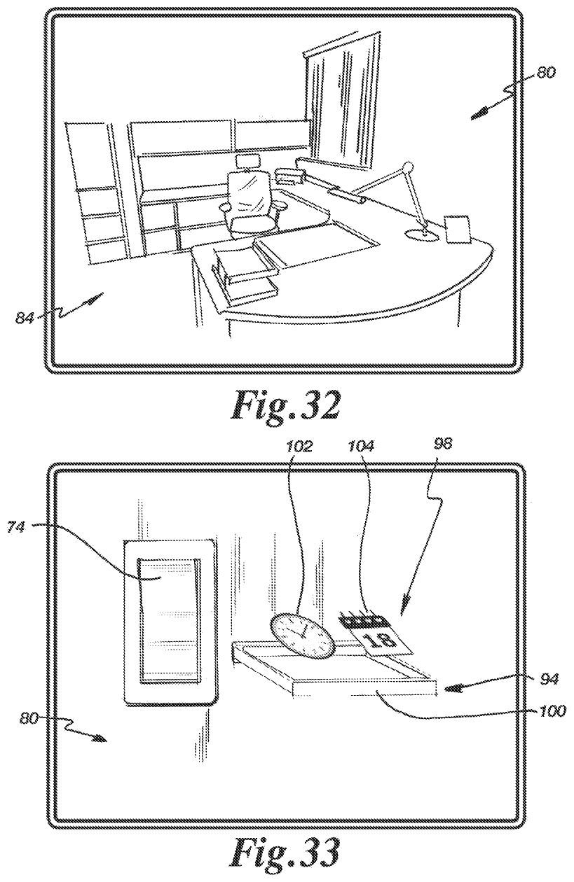

In at least one embodiment as may be seen in FIG. 29 an individual is wearing a user interface device 96 such as visible light transceiver glasses 318 and motion sensitive gloves. The individual in FIG. 29 is accessing the operating exchange 80 for a building 50 through the user interface devices 96. In FIG. 30 the individual is moving to enter into a premise site for a virtual cyber office location having LED pulsed light fixtures 56 and VLEC capabilities. As may be seen in FIG. 31 the individual in the virtual cyber office location is walking down a hallway 82. In FIG. 32 the individual has entered into a virtual office and in FIG. 33 the individual has moved to a virtual light switch 74 and a control element access panel 94 as adjacent to the virtual light switch 74. As may be seen from FIG. 33 the individual has virtually opened the control element access panel 94 in order to manipulate one of the virtual control elements 98 depicted as a clock or a calendar as earlier described. As depicted in FIGS. 29 through 33, an individual through the user interface devices 96, and the operation exchange 80 for a cyber-location, may in real time alter the status of a remote building function, through a virtual presence and manipulation of a virtual control element 98 as disposed in a control element access panel 94.

In one embodiment, the pulsed light communication system is integrated with an intelligent video/audio observation and identification database system which is utilized within a defined area or zone to track the entry, exit and location individuals, and to identify profile parameters for the individuals within the zone. The intelligent system is utilized to analyze movement and to assess information processed and stored from a continuously evolving database.

The intelligent video/audio observation and identification database system will search and/or identify all individuals entering into a zone or area. The system will identify information through the use of cameras, video cameras, and microphones along with a facial recognition, and other biometric information. The system will record the time, date, and place of entry into the zone and exit from the area, and personal information concerning the individual. The system will compare a photographic image from a publically available source to the optical image obtained by the camera and the facial recognition software or biometric information will be used to identify and track individuals and movement within an area.

The accumulation and storage of the information of the type identified above will be located within a continuously updating and evolving database. For instance, on a given day, an authorized individual may search the recorded information within the accumulated database to inquire as to the identity and location of all individuals within a zone. The processor for the intelligent video/audio observation and identification database system 420 will then advise the appropriate custodian for the zone of the individuals identified and location from the search.

The tracking of individuals within the an area is accomplished through the use of a plurality of optical devices which may be cameras, digital cameras, and/or other types of recording devices which are either mounted in a static and/or active position. Each of the devices is preferably linked to a continuously evolving database to record information which may be processed and retrieved for use by authorized personnel. It is anticipated that a sufficient number of optical devices will be utilized such that the observation fields for each individual optical device overlap to provide continuous observation of all desired areas.

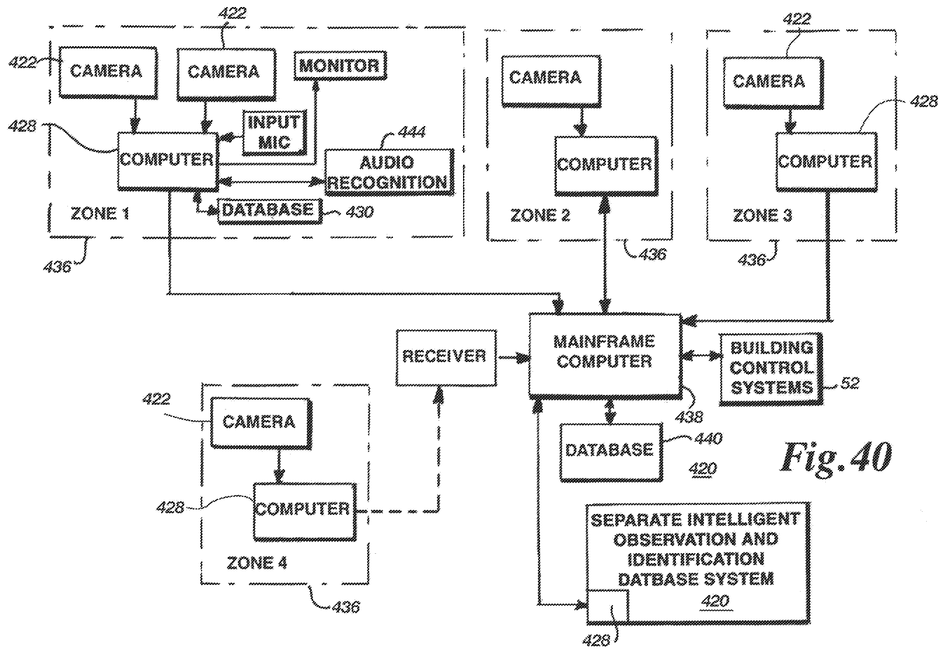

Referring to FIG. 40, the intelligent observation and identification database system 420 generally comprises an optical input device 426, such as a camera 422, a computer 428, including a processor, an evolving database 430, which may be located inside the computer 428, and an output device 432, such as a monitor.

The system 420 may also include other input devices 434, such as fingerprint scanners, palm scanners, microphones, retinal scanners, facial scanners and the like. The various other input devices 434 and optical input devices 426 may be classified into zones 436. The computer 428 thus may receive input from a plurality of zones 436. Further, each zone 436 may include its own computer 428 and evolving database 430. Each evolving database 330 may contain predetermined information, such as data, standard images and descriptions of including the front, side and rear profile for the individual and further specifications such as skin color, hair color, facial hair, hair length, body type, height, width, and weight to name a few to assist in the personal identification of the individual. Further information such as facial images and profile images, fingerprint images, palm print images, voice samples and the like are also accumulated and entered into the evolving database 430. Each evolving database 430 is also capable of being updated according to data saved by the system. Optionally, a plurality of computers 428 in a plurality of zones 436 may be in communication with each other, and also may be in communication with a mainframe computer 438 or server, which may have a mainframe database 440. When a number of zones 436 are linked to a mainframe computer 438, each zone 436 could alternatively be classified as a sub-zone, with the system 420 being the entire perimeter of all combined sub-zones.

An overview of the method utilized with the intelligent audio/visual observation and identification database system 420 initiates with the identification of a zone 436. Next, individuals identify the positioning of optical assist and/or recording devices 426 to establish fields of observation to completely enclose the identified zone 436. Individuals next place the optical input devices 426 in accordance with the identified desired positions for the optical input devices 426 to observe the zone 436.

The optical input devices 426 are next connected to a network and computer 428 which may be centrally located within a zone 436. Software is preferably loaded onto the computer 428 for creation of individual files representative of individuals 442. Access software is used to communicate with internal databases 430, 440 or external or remote databases, and comparison software is used to review data as related to the external and/or internal databases 430, 440. Sensitivity software is also used to establish thresholds and to further aid with the identification of the individuals 442 which may be displayed on the output device or monitor 432, and categorization software may be used to divide data within individual files or images captured by the input devices 426, 434 into coherent segments. In addition, any other software as desired by may be utilized. Individuals will next verify the operational status and accuracy of the computer operation for the intelligent audio/visual observation and identification database system 420 to insure functioning prior to implementation. The computer 428 will then be connected to the individual zone 436 network of optical input devices 426 for testing as to an operational status. Next, the computer 428 will be connected to a network comprised of a plurality of zones 436 to insure operational communication therebetween.

Next the intelligent audio/visual observation and identification database system 420, including the optical input devices 426 and other input devices 434, will be initiated. The computer 428 will then accumulate data and build a database 330, 430 for observed individuals 442 within the individual zone 436.

The optical input devices 426 will then observe individuals 442 where the computer 428 will access internal databases 430, 440 and external databases to identify information related to the individual 442.

The computer 428 may next implement either standard or customized queries or searches for defined profiles related to individuals 442 within the accumulated database 430, 440 for the security zone 436. Upon identification of individuals 442 which satisfy the profile criteria, a communication signal will be generated to appropriate personnel as to the status, location, or other appropriate information including notices, warnings and/or advertisements for the individuals 442 under consideration within the zone 436.

The computer 428 may then additionally access the network of the plurality of zones 436 for information as related to a current condition within the initial zone 436. These inquiries may be global, or may be limited to specific periods of time or other specific conditions.

The intelligent observation and identification database system 420 preferably utilizes an entrance or an exit to a zone 436 to optically observe and input, at both the entrance and the exit, information to record and store within the database 430 for identification of regular and repetitive conduct of specific individuals 442 within the zone 436.

Optical input devices 426 may include cameras 422, digital cameras, charge-coupled devices, video cameras, scanners and any other appropriate devices to record an image. The optical input device 426 desirably records a plurality of digital images for analysis by the computer 428.

The computer 428 for the intelligent audio/visual observation and identification database system 420 preferably is sufficiently sophisticated for tracking of an individual 442 as the individual 442 passes through a plurality of independent optical input devices 426 or other input devices 434 as previously discussed. In this regard, the computer 428 receives data independently from one or more input devices 426, 434 for analysis against pre-stored and/or prerecorded data in the database 430 related to the individual 442. In this regard, it is not required that the first optical input device 426 observe all relevant data related to the individual 442. As the individual 442 approaches and passes into the viewing area of additional optical input devices 426, a perpendicular observation alignment may occur where the side profile may be readily ascertained. It is therefore anticipated that the intelligent audio/visual observation and identification database system 420 simultaneously and continuously receives data from all input devices 426, 434 for processing. All input data may further be stored within a continuously evolving database 430.

The intelligent video/audio observation and identification database system 420 desirably records an image of the individual 442 for storage of the time and date of the recording, and digital images representative of the individual 442 including appearance characteristics.

Often it is desirable to keep the input devices 426, 434 hidden from view of the individuals 442. The input devices 426, 434 may be disguised within various enclosures.

When the input devices 426, 434 are hidden, or when the use of a visible flash is undesirable, the system 420 may make use of IR flashes, which generally produce light which is not visible to the human eye and can include an IR band-pass filter to completely remove visible light.

When an image of the individual 442 is recorded, the computer 428 may analyze the image to determine the individual's identity. Desirably, the computer 428 performs an optical recognition to extract the data pertaining to the individual 442.

Personal data recorded such as photo images, finger or thumbprints, palm prints, retinal scans and voice captures, may be compared to similar prerecorded files stored in the database 430 in order to verify and/or identify the individual 442. Thus, it is desirable for the database 430 to contain relevant information of all persons who regularly pass through the zone 436. Personal data may be grouped according to any standard in order to facilitate searching within the evolving database 430.

Thus, the system 420 over time may be capable of automatically identifying individuals 442 entering into the zone 436 and recording the entry time, location, departure. And profiles/patterns related to typical or expected conduct within the zone 436.

The system 420 may be used to compare the prerecorded personal information contained in a database 430, 440 or an external database related to the identified individual 442 with the observed information to verify deviations from the observed information. In this regard, the intelligent video/audio observation and identification database system 420 constructs an individualized database 430 for a zone 436 which is customized, in real time, to automatically detect a discrepancy and to flag observed criteria to facilitate safety and security for a desired zone 436.

Further, separate zones 436 within the intelligent video/audio observation and identification database system 420 may be in communication with each other. For example, a building may have a first zone 436 defined as the exterior perimeter and parking structure, a second zone 436 for the building lobby, and an additional zone 436 for each floor of the building.

Additionally, separate intelligent video/audio observation and identification database systems 420 may be connected together, for example via the internet, for communication with one another. Separate intelligent video/audio observation and identification database systems 420 may be located in adjacent areas within the same building or in separate adjacent buildings.

The computer 428 for the intelligent video/audio observation and identification database system 420 may include an interface between any number of application specific databases 430, 440 which in turn may be coupled with screening and/or searching functions to identify individuals 442.

The intelligent video/audio observation, identification and database system 420 thereby provides a real time network of transmitted information for verification of data related to an individual 442 adjacent to or within a zone 436.

An intelligent observation and identification database system 420 may be arranged to learn the expected times for arrival and departure of individuals 442 from various zones 436. Each time an individual 442 enters or exits a zone 436, the system 420 may record in the database 430 the time and location of the arrival or exit. Thus, over time, the system 420 may learn the expected arrival and departure times based upon the average of a predetermined number of instances, or by the most common of a range of predetermined times, such as normal shift times. Thus, if an individual 442 attempts to enter or exit a zone 436 at a time other than the learned expected time of entry or exit, the system 420 may automatically identify a discrepancy for evaluation by suitable personnel.

A computer 428 may store information within the database 430 pertaining to an individual 442 based any desired classification system.

A computer 428 may compare the observed data to the prerecorded and stored data to implement a search for any discrepancies. If any threshold discrepancy is identified, then a signal may be automatically communicated to an appropriate individual.

Further, if the computer 428 discovers any alerting information resulting from the database 430 search, the system 420 may automatically issue an alert, as well as display all available image and recorded data pertaining to that individual 442 upon a monitor, a plurality of monitors in predetermined zones 436, or all monitors within the system 420. The system may additionally issue an audible alert and a supplemental visual alert, such as a flashing light or audible alarm.

The intelligent video/audio observation and identification database system 420 may also retrieve pre-recorded images or other data from the database 430 concerning an individual 442 which has been tracked within the zone 436. This tracking feature allows appropriate personnel to input a query search for information concerning the individual 442. The computer 428 may display all available description information pertaining to the individual 442 on a monitor in response to the search report.

In this regard, the intelligent video/audio observation and identification database system 420 may have pre-programmed flags and/or thresholds for triggering of the provision of tasks or signals to appropriate personnel. The computer 428 may record and/or track the number of points or flags assigned to a particular individual 442. When a certain number of flags and/or points have been assigned, according to a previously stored profile, then the computer 428 will emit or issue a signal to an individual, which may be ranked against other tasks in order of importance. An appropriate individual receiving the signal will respond to the signal according to a previously established priority policy for low, medium and high attention.

Further, priority levels with respect to tasks, and the threshold levels at which tasks are grouped into priority categories, may be adjusted by authorized personnel. Thus, stored data of previous priority assessments will be available for retrieval and analysis in order to adjust and/or recalculate a flag or point threshold for future contacts.

It is anticipated that the software as integral to the computer 428 for the intelligent video/audio observation and identification database system 420 will include processing capability from static optical devices 426 such as cameras, where the software may be used to track a person 442 within a zone 436. Such software will establish particular detail boxes and/or zones within a visualized image or group of images, such that the detail boxes will follow and track the transition of a specific object across a viewing zone. Tracking may be accomplished according to deciphering of image data as disclosed above. An individual 442 under investigation may therefore be specifically located within a zone 436 and/or tracked to a specific location.

The intelligent audio/visual observation and identification database system 420 may further be arranged to track individuals 442 as they move from zone 436 to zone 436. Tracking may be accomplished by recording the location and time for each instance when the system 420 identifies the individual 442 entering, exiting, or records the individual 442 at any particular point within any particular zone 436. Thus, tracking priority may normally generate a log of when and where the individual 442 was observed within a particular zone 436. Over time, the system 420 may learn typical paths, conduct, times and zones 436 where specific individual 442 spend their time.

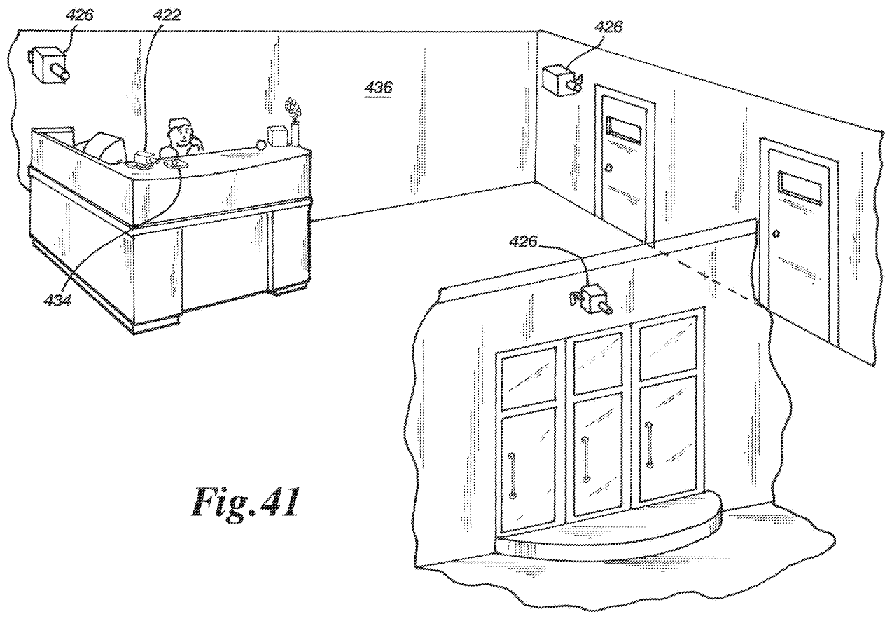

FIG. 41 depicts a room having multiple input devices 426, 434. The other input device 434 shown may be a palm reader. A plurality of cameras 422 may be located within a room. Another camera 422 may be mounted to observe activity outside the depicted room. Thus, the cameras 422 may be arranged to allow the system 420 to track a person 442 as the person approaches and enters the room, and as the person moves around within the room.

The computer 428 for the intelligent audio/visual observation and identification database system 420 preferably includes software to search for discrepancies from previously normalized data representative of historic actions related to an individual 442. A mainframe computer 438 may also initiate search or inquiries of the evolving databases 430 or 440 within a zone 436 for identification of desired information.

The computer 428 may further implement a query to identify the current location of all individuals 442 which have satisfied the profile search parameters. The computer 428 will then communicate to an appropriate individual the location of the individuals 442 which satisfy the profile parameters within the zone 436.

During pattern learning, the computer 428 sensitivity may be established by the initial creation of a file and/or data pertaining to an individual 442. Next, the input of a desired amount of data representative of repeated actions may be required. The number or amount of data may represent 20, 50, 100, or 200, repetitive occurrences. The occurrences may be required to be within a certain classification, such as all within a certain zone 436, or all within a certain period of time during the day, such as between 3 and 4 o'clock p.m. The computer 428 may then calculate a mean value based upon the recorded data. Alternatively, the recorded data may be divided into more than one segment and a mean may be calculated for each desired segment. The computer 428 will generally continue to store data, and therefore update the pattern, as detected by the input devices 426, 434. The computer 428 is preferably designed to recalculate a mean for the data following each additional data entry. The computer 428 may include sensitivity trigger software which will identify a desired threshold deviation from the calculated mean which may be more or less than one standard deviation. Alternatively, the sensitivity trigger may be established at a certain percentage for deviation from the calculated mean. In some embodiments, the computer 428 continually compares the observed occurrence information to the calculated mean data to determine if investigation signals are required to be communicated. In this respect, the computer 428 is engaged in updating activities and becomes smarter and more efficient in analyzing behavioral patterns over time.

The intelligent audio/visual observation and identification database system 420 may also be simultaneously coupled to an audio recognition system 444 within a structure. The audio recognition system 444 may be included within the computer 428. Initially, the audio recognition system 444 comprises a plurality of microphones or transducers as electrically coupled to the computer 428 which has access to the database 430, which desirably contains stored data representative of vocal or other sounds, words, patterns of words, and/or phrases of individuals 442. The audio recognition system 444 may be an initial supplemental verification system for identification of an individual 442. The audio recognition system 444 may be further coupled to other verification systems for an individual 442 such as fingerprint, thumb print, palm print, and/or eye scanners as previously disclosed.

The audio recognition system 444 may interpret vocal sounds/commands and input the sounds/commands into the intelligent audio/visual observation and identification database system 420, which may be in communication with building operating systems 52. Thus, the intelligent audio/visual observation and identification database system 420 may be coupled to the operational systems for a structure. The operating system for a structure may regulate locking systems for doors, lighting systems, air conditioning systems, and/or heating systems. Thus, facility control units 72 may be activated by authorized personnel through voice recognition of vocal commands through the intelligent audio/visual observation and identification database system 420. The audio signals communicate to the transducer may be verified with respect to pre-stored data for the authorized person, or may be automatically opened or activated based upon a signal generated by the computer 428 following the audio recognition of the authorized person. Activation of a system may occur in the same or different zone 436.

The intelligent audio/visual observation and identification database system 420 may also be coupled to sensors as disposed about a structure. The system may then build a database 430 with respect to sensors within specific locations, pressure sensors, motion detectors, sound transducers, and/or smoke or fire detectors. Recorded data as received from various sensors may be used to build a database 430 for normal parameters and environmental conditions for specific zones 436 of a structure for individual periods of time and dates. The computer 428 may continuously receive readings/data from remote sensors for comparison to the pre-stored or learned data to identify discrepancies therebetween. In addition, the filtering, flagging and threshold procedures as earlier identified may be substantially duplicated with any desired adjustment to assigned points or flags for an environmental area to indicate a threshold discrepancy. The reassignment of priorities and the storage and recognition of the assigned priorities occurs at the computer 428 to automatically recalibrate the assignment of points or flags for further comparison to a profile, prior to the triggering of a signal representative of a threshold discrepancy.

The intelligent audio/visual observation and identification database system 420 may also be coupled to various infrared or ultraviolet sensors, LED ultra-violet lights or other types of ultraviolet lights used within a structure.

A desired number of recordings and point or flag thresholds for individuals 442 may be adjusted to fulfill the level of scrutiny desired within a particular zone 436. During the entire evaluation and storage processing, the computer 428 is recording not only images and data relative to an individual 442, but also desirably recording data related to the sensitivity of the scrutiny level to be assigned to the particular individual 442. In this regard, the computer 428 becomes more intelligent when a variation in previously recognized parameters is not satisfied.

Therefore, the longer the intelligent audio/visual observation and identification database system 420 is utilized within a specific zone 436, the more customized the system 420 becomes to address the requirements of the specific zone 436 to provide a desired level of scrutiny.

The use of pre-stored profile queries in conjunction with manual customized queries enhances the performance of the intelligent video/audio observation and identification database system 420 within a particular zone 436.

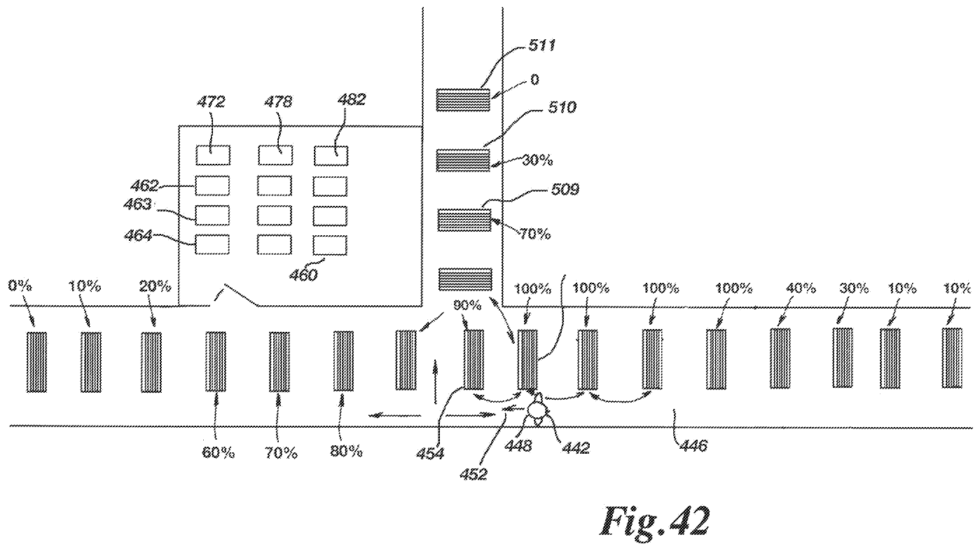

In at least one embodiment, as shown in FIG. 42, the VLEC XCVR device or fixture 122, 10 may be used in conjunction with the LED lighting in hallways, rooms, etc. to reduce energy consumption. For example, all the lights in a hallway may have a standby setting such that they are relatively dim or even off. As a person with a portable device 30 having, or modified to include, pulsed light communication capabilities proceeds down a hallway, the lights in front of the person may turn on in response to a transmitted signal such as a unique code. As the person moves beyond a light, the light returns to its standby setting of dim/off brightness through a signal communicated from a XCVR 122. The signal is issued when the individual has passed, and is no longer present at a particular location. The presence of an individual proximate to an XCVR 122 may be determined by either recognition of a signal or through the failure to continue to recognize a signal, or by a proximity calculation as based on a controller receiving a signal from a remote location, which indicates recognition of a pulsed light communication. A proximity is then calculated where initial or previous XCVR light sources 122 are extinguished as an individual passes a particular location. In other embodiments, the lights can gradually become brighter, as a percentage of full brightness, as a person approaches, and then gradually dim, as a percentage of full brightness, as a person moves away based on proximity calculation as earlier described.

As shown in FIG. 42, the person 442 is approximately adjacent to light 450 and traveling in the direction shown by arrow 452 towards light 454. From this position, person 442 might prefer to be able to see into the branching corridor containing lights 456-458. Since different persons will have different destinations, adjacent illumination may be illuminated according to custom programming. Again, the level of illumination may additionally vary with relation to the person, the geometry of the building space, in accord with personal preferences, or for other reasons.

When person 442 has traveled farther, lights 456-458 may be extinguished. Other lights are automatically shut-off or dimmed according to a program which may be formed from an evolving database 430. As FIG. 42 illustrates, lights within room may similarly be activated and controlled, so for exemplary purposes as illustrated, light 460 may be at full intensity, lights 462-471 may be extinguished completely, and light 472 may be operating in a greatly dimmed state, but still providing adequate lighting to facilitate sight by an individual 442.

The present invention reduces the extent of human interaction required to control various functions such as light switches and thermostats, while simultaneously increasing the capabilities of such controls. Individual or selected groups of lights may be selectively configured for optimal physiological and psychological effects and benefits for one or more applications, and then may be readily reconfigured without changes to physical structures for diverse applications having different requirements.

Such embodiments are an improvement over conventional motion detectors, due to the “smart” nature of the optical XCVRs. Rather than waiting for a time delay as is the case with motion detectors, the optical XCVRs (and in some embodiments the optical XCVRs in conjunction with software) in the lighting fixture recognize immediately that the person has moved beyond a particular light, allowing that particular light to be dimmed or turned off Also, this smart technology may be used to turn lights on only for people with the correct code embedded in their portable XCVR. In such an embodiment, the user can walk into a restricted area, and if not authorized to be there, the lights would remain off, and if authorized the lights would turn on.

In other embodiments of the invention, the number of occupants within a space 436 may be used not only for anticipating illumination, but also to control operation of other machinery within the building. Exemplary of this, but not limited thereto, are water and HAVC systems and other electrical or electrically controllable devices.

The intelligent audio/visual observation and identification database system 420 may also be coupled to a VLEC/XCVR system or sensors as disposed about a building. The system may then build a database 430 with respect to temperature sensors within specific locations, pressure sensors, motion detectors, communications badges, and sound transducers. Recorded data as received from various sensors may be used to build a database 430 for normal parameters and environmental conditions for specific zones 436 of a structure for individual periods of time and dates. A computer may continuously receive readings/data from remote sensors for comparison to the pre-stored or learned data to identify discrepancies therebetween.

The LED XCVR light fixture in some embodiments may be rectangular and the LED light units may be disposed in rows as shown in FIG. 4.

In at least one embodiment, the panel shown in FIG. 4 includes a LED transceiver unit, a power unit, and a Broadband over Power Line (BPL) decoder. Power enters power unit through a cable. The power may include the Orthogonal Frequency-Division Multiplexing (OFDM) signals as carried over the power line. In some embodiments, the OFDM signals are pulled off the power line by the BPL decoder converting the OFDM signals to data signals which are then transferred by a cable (which may be a Cat 5 or Cat 6 cable) to the transceiver unit which includes circuit boards forming the controller to regulate LED pulsed light illumination, communication and/or information/data transfer from LED light units. The transceiver unit is in communication with the photodiodes on the front of the LED XCVR light fixture for transfer or communication upstream as digital signals through a cable to the BPL Decoder which in turn may convert the data signals to OFDM signals over a power line to a different designated XCVR transceiver unit as integral to another LED XCVR light fixture or other computing device which may be a server.

In one alternative embodiment an LED XCVR light fixture 474 may have horizontal strips of LED light units where each strip of LED light units may include between 8 and 24 or more individual LEDs. In alternative embodiments, each strip LED light unit may include a larger or smaller number of LEDs as desired for a particular application or size of light fixture.

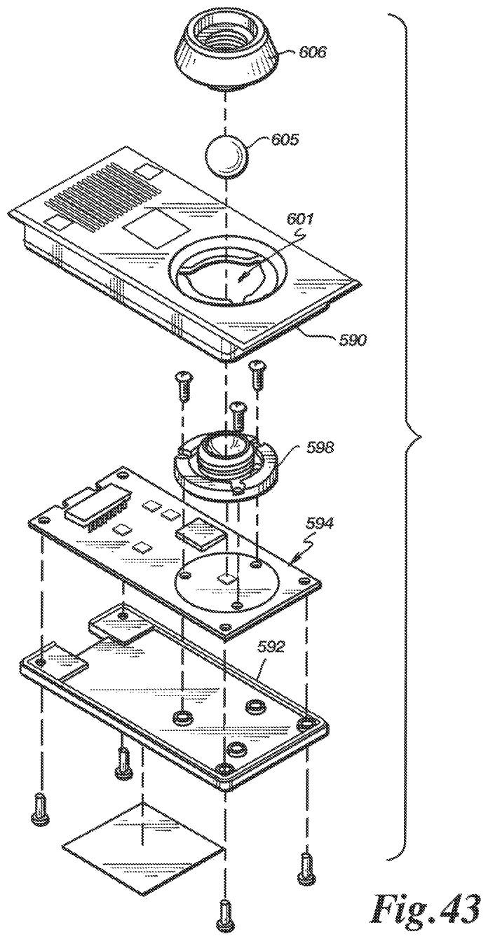

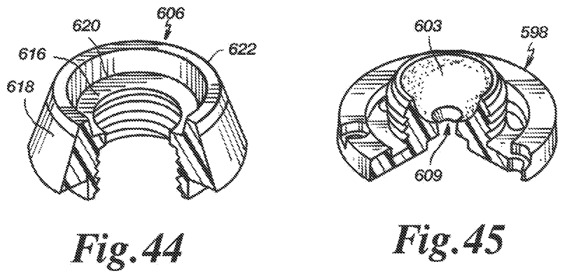

In at least one embodiment as depicted in FIGS. 43 through 45, LED light fixture will include an outer casing 590 and a lower casing 592 inside the outer casing 590. The lower casing 592 is preferably disposed proximate to the main circuit board 594. An LED 596 is preferably in electrical communication with one or more circuit boards 594. In some embodiments, an inner lens retainer assembly 598 is disposed on circuit board 594 over LED 596. The inner lens retainer assembly 598 preferably traverses opening 601 through outer casing 590. The inner lens retainer assembly 598 in some embodiments includes a semi-spherical or parabolic surface 603 which is constructed and arranged to receive a spherical object or ball lens 605. In some embodiments, the lens 605 is not required to be spherical in shape.

In some embodiments, a portion of the exterior surface of the inner lens retainer assembly 598 is threaded and is constructed and arranged to receive the threads of an outer lens retainer assembly 606.

In some embodiments the semi-spherical or parabolic surface 603, which is constructed and arranged to hold a spherical object or ball lens 605, is polished. The inner lens retainer assembly 598 preferably includes a light passage opening 609 which is disposed above an LED to permit light to enter spherical object or ball lens 605. It should be noted that in some embodiments that spherical object or ball lens 605 may be semi-spherical or flat.

In some embodiments as depicted in FIG. 23 the outer lens retainer assembly 606 includes surfaces 616, 618, 620, 622. In some embodiments, surface 616 is disposed at least partially over spherical lens 605 to releasably and securely position spherical lens 605 in the semi-spherical or parabolic surface 603. In some embodiments one or more surfaces 616, 620 and 622 may be polished to enhance performance of transmission of light including communication and/or information/data transmissions.

In some embodiments, surface 618 is the exterior surface of the outer lens retainer assembly 606 and may be used to rotate and secure the outer lens retainer assembly 606 over the inner lens retainer assembly 598.

In at least one embodiment, a light emitting diode light source capable of emitting pulsed VLEC signals as previously described will include a plurality of ultraviolet LED light sources 125. It is anticipated that a plurality of VLEC LED light fixtures 10, each having a plurality of ultraviolet LEDs 125, will be placed into a ceiling of a room or hallway of a building 50. Any desired number of VLEC LED light fixtures 10 will be used to simultaneously generate visible light from the LEDs 124 for illumination and exchange of VLEC signals and to emit germicidal irradiation from the ultraviolet LEDs 125.

Each VLEC LED light fixture 10 will be regulated by a controller 20 as earlier described. The controller 20 is also in communication with the ultraviolet LEDs 125 to regulate power, intensity, duration, timing, pulsation, frequency, duty cycle, wavelength, and/or any other lighting parameter/factor, in any combination, or individually, to provide germicidal irradiation within a room, area, or other location, to facilitate sterilization of an environment.

As may be seen with reference to FIG. 4, it is anticipated that the generation of ultraviolet light from the VLEC LED light fixtures 10 having ultraviolet LEDs 125 will sterilize surfaces within a room, hallway or other environment, as well as air borne contaminates. In some embodiments the controller 20 will regulate any desired intensity or duration parameter dependent upon whether a surface or air within an environment is to be sterilized.

In a preferred embodiment, a VLEC LED light fixture 10 will include a light sensor 128, a motion detector 130, a heat source or temperature sensor 132, an air movement sensor 134, a sound sensor 136, or any other type of sensor to detect the presence of an individual or an animal within an environment to be sterilized with ultraviolet irradiation. The sensors 128, 130, 132, 134 and/or 136 are preferably in communication with the controller 20 and will function as a safety mechanism to eliminate risk of exposure of harmful ultraviolet irradiation to an individual or pet within an environment. The detection of a condition by one or more of the sensors 128, 130, 132, 134, and/or 136 will act as an override to terminate or to prevent activation of the transmission of ultraviolet light within an environment.

In at least one embodiment, the controller 20 and sensors 128, 130, 132, 134, and/or 136 will operate in conjunction with an evolving database 430 to identify the normal ambient light, air currents, sounds and temperature conditions within an environment when an individual or animal is not present within an environment to provide a base reference condition as stored in the evolving database 430. Any sensed condition deviating from the base condition will cause the override and disengage emissions of ultraviolet light from the LEDs 125. Risk of harm to an individual or to a pet is therefore minimized.

As previously identified the controller 20 may be programmed to include restrictions as to the dates, times, initiation, duration, termination, intensity, and location for the emittance of ultraviolet light similar to the emission of visible light within an environment. The controller 20 may regulate the emission of ultraviolet light to times and areas, such as the middle of the night, when individuals and/or pets will not be in a specific area.

In a commercial environment, during non-business hours, the controller 20 in conjunction with a VLEC LED light fixture 10 may recognize the presence of a security guard at a certain location within a structure. The controller 20 will then signal specific VLEC LED light fixtures 10 removed from the location of the security guard to emit ultraviolet light within a removed area for a pre-established duration of time to improve sterilization within a building 50. Other areas may be exposed to ultraviolet irradiation, or the ultraviolet irradiation may be extinguished as the security guard moves through the building as sensed by the VLEC LED light fixtures 10.

In some embodiments, a controller 20 in a building 50 may include a safety feature requiring entry of an activation code authorization prior to the operation of an ultraviolet sterilization procedure from the LEDs 125. A keypad code, thumb print scanner, card reader, palm scanner, retinal scanner, or other biometric scanner may be required prior to the initiation and/or operation of an ultraviolet sterilization procedure.

In at least one embodiment the controller 20 may vary one or more parameters to provide germicidal irradiation to air or to surfaces within an environment.

In another embodiment, the controller 20 of the VLEC LED light fixture 10, including the ultraviolet LEDs 125, will include programmed features to warn individuals within an area that an ultraviolet sterilization procedure is scheduled to begin. In this embodiment, the controller 20 may regulate the LEDs emitting visible light from the VLEC LED light fixture 10, to brightly flash in a pre-established pattern, prior to the activation of the ultraviolet LEDs. The warning flashing signal may be similar to a flashing signal which may be displayed as a fire alarm warning.

In addition, a speaker integral, or in communication with, the VLEC LED light fixture 10, may be initiated by the controller 20, in order to issue one or both of an audible verbal warning, or an audible warning signal such as any desired type of siren. One or both of the audible verbal warning and the audible siren type of warning signal may vary in decibel level as required for a particular area. It is anticipated that the audible siren type of warning signal will be sufficiently loud to require individuals to egress from a designated area. It should also be noted that the controller 20 operated flashing visible warning signal, as well as the audible verbal warning and/or the audible siren type of warning signal, may be emitted in any desired type of environment including but to limited to office buildings, commercial environments, schools or universities, as well as government buildings to name a few.

A further safety feature may be required by the controller 20 as a prerequisite to the initiation of an ultraviolet sterilization procedure for an area. A VLEC LED light fixture 10 using a camera, facial recognition software, and an evolving database 430, may continuously monitor an area in order to identify the presence of authorized individuals. The subject area having a door. As a prerequisite to the initiation of an ultraviolet sterilization procedure, the controller 20 may be programmed to require that the last authorized individual exiting a subject area to activate a safety switch, and immediately thereafter close the door during egress, in order for the sterilization procedure to be placed into a scheduling program for receipt of ultraviolet irradiation. The controller 20 would not authorize the emission of ultraviolet light for the subject area unless the appropriate switch was activated by an authorized individual, the individual was the last individual to exit the designated area leaving the area unoccupied, and the door to the area had been closed and/or locked.

In the event that the above identified programmed procedure was not followed at the time of the exit of the last authorized individual from an area, then a security guard or custodian at a later time may enter into an area for inspection, and follow the programmed procedure to authorize sterilization treatment. It should be noted that the controller 20 will not authorize the emission of ultraviolet irradiation from the ultraviolet LEDs 125 if a VLEC LED light fixture 10 detects the presence of an individual within an area or environment. Therefore, both a human input as well as an artificial intelligence evaluation may be required as prerequisites for germicidal irradiation of an area through the use of the ultraviolet LEDs 125.

In at least one alternative embodiment, a personal electronic device 30, examples of which include headphones, earbuds 350, glasses, transceiver glasses 318, cellular telephones or other devices may include speakers 40 and may be in communication with a VLEC system. In addition, the personal electronic device 30 may include a plurality of sensors which sense the elevation, direction, and movement of an individual's head as related to a source of sound detected by microphones 38. The microphones 38 will be in communication with the personal electronic device 30. The sensors will detect the direction an individual is facing or moving relative to a sound source in real time, and as the location of the personal electronic device 30 changes relative to the location of the sound source, a controller 20 in communication with the personal electronic device 30 will modify the sound generated by the speakers 40 in order for the location of the sound source to remain stationary even though an individual's head is moving relative to the sound source which is perceived as being stationary.

The sensors integral to the personal electronic device 30 may include motion, elevation, direction and/or acceleration sensors to detect and to communicate relative motion of the personal electronic device 30 or the individual's head relative to the location of a sound source. For example, the sound source such as a bird song may be transmitted through speakers 40 in a set of headphones 350 for communication to an individual. As an individual turns, the individual's head may move in any direction, where the detected bird song will remain in a static location as transmitted through the personal device 30 to an individual.

The invention herein will locate the position of the bird song relative to the personal electronic device 30 and the processor 20 and sensors will work in conjunction, so that the location of the transmitted bird song remains stationary, at a single location relative to the movement of the personal electronic device 30. A realistic detection of the location of sounds relative to a personal electronic device 30 may then occur. In another embodiment, an infrastructural apparatus operating system is provided.

The infrastructural apparatus operating system (iA operating system) is based on recorded visual observation and gestures as well as movement. Visual images will be recorded by a personal electronic device 30 through devices such as cameras 36 which may be integral to transceiver glasses or goggles 318. The personal electronic device 30 will also include GPS coordinate detection and communication features, motion sensors, and pulsed VLEC features as well as directional sensors.

During use a personal electronic device 30 will continuously record and store the visual images of an existing physical environment. The GPS coordinate detection and communication features, as well as the directional sensors, create a recorded and stored “cyber environment” which is a realistic recording of the actual physical environment as may be observed at, or in, any desired direction by an individual.

The iA operating system does not communicate by use of language. The iA operating system communicates by sensed movements made by an individual using the personal electronic device 30 within an environment. The personal electronic device 30 includes at least one controller 20 which provides for the generation and receipt of pulsed VLEC communications.

An individual uses the personal electronic device 30 to enter into the cyber or simulated environment which has been previously recorded. An individual may through gestures, or other movements, move within the cyber environment. An individual within the cyber environment may access devices, components, or items as previously recorded. For example, an individual located at a remote location with the proper credentials, may enter into a cyber environment representing an individual's house, and move within the cyber kitchen area, and to a location in front of a refrigerator. The individual then through gesture or other action open the refrigerator door to observe the previously recorded contents of the refrigerator, in order to determine the existence or absence of a food item being considered for purchase.

During periods of time where an individual is physically present within an environment to be recorded as a cyber environment, the personal electronic device 30 of an individual will record images of the physical environment. In the event that the currently observed and recorded physical environment is different from the previously recorded cyber environment, then the cyber environment will be updated to the most recently observed and recorded real environment. The cyber environment will not change unless the actual environment has previously changed. For example, a traffic sign will likely not change in location unless a city employee has removed or modified the traffic sign. However, if an item within the actual environment has moved, for example an item on a shelf or counter has been moved within an area, then the cyber environment will be updated to conform to the recorded images of the physical environment. Each recorded observation of the physical environment receives an identification/location tag for storage and processing within an electronic storage device or evolving database 430 so that an individual is permitted to access the cyber environment as desired.

In another embodiment, the cyber environment may include additional cyber items or features which are clearly identified to an individual. For example, an individual using a personal device 30 located within an office environment may recognize a desk having drawers. The individual through gesture or other action may open the “desk drawer”. The actual physical contents of the “desk drawer” may then be displayed. Alternatively, the “desk drawer” when opened in the cyber environment may contain “cyber items” such as an accounting program, financial/banking items, a word processing program, or a filing system to name a few. The individual using the personal device may then access the clearly identified “cyber items” to access desired programs or information and to take desired action within the cyber environment.

In addition, a personal electronic device 30 including pulsed light communication capabilities as connected to the iA operating system may communicate directly with another individual who is physically present in the actual environment or is also present in the cyber environment.

Another example of the iA operating system may be a public library where an individual enters a cyber library environment and moves to a stack or shelf of books, and identifies a specific book. Through gesture or other actions the individual may retrieve the desired book and open the book to access the contents. No language or written or verbal instructions are required in that the features of the iA operating system are controlled through actions/gestures within a previous visual recording of an environment. In at least one embodiment, any “cyber items” or “supplemental cyber locations or features” are clearly identified to a user.

The present invention is directed to a ubiquitous Network Platform/Computer Operating System where traditional screen displayed Control Icons are replaced with real world

Virtual Reality “life like” 3-D animations/simulations, all items within forming working Control Icons connected to real time/spatial coordinates, the simulation being simultaneously updated but not limited to, iA and any/all connected service appliances, program applications, outside collected contributing data sources and any other I.O. forum.

In a first embodiment, an infrastructural apparatus operating system includes:

a personal electronic device having a device camera, a device sensor, a device controller, a device display, a device photodetector, a device identifier, and plurality of device light emitting diodes, the device camera observes a physical environment, the device controller regulating the plurality of device light emitting diodes transmitting images of the physical environment within a device issued pulsed visible light embedded communication signal, the images having element images;

a visible light embedded communication fixture having a plurality of fixture light emitting diodes, a fixture controller, a fixture memory, a fixture identifier and a fixture photodetector, the fixture photodetector receiving the device issued pulsed visible light embedded communication signal, the fixture controller storing the images and the element images in the fixture memory within a cyber environment, the fixture controller assigning control icons to the element images within the cyber environment, the fixture controller regulating the plurality of fixture light emitting diodes transmitting a fixture generated pulsed visible light embedded communication signal having the cyber environment and the control icons;

the device photodetector receiving the transmitted fixture generated pulsed visible light embedded communication signal having the cyber environment and the control icons, the device controller processing the fixture generated pulsed visible light embedded communication signal having the cyber environment and the control icons and transferring the cyber environment and the control icons onto the device display;

the device sensor detecting motion of the personal electronics device, and the device controller processing the motion and identifying at least one of the control icons, the device controller regulating the plurality of device light emitting diodes transmitting the processed motion and the identification of the at least one control icon within another device issued pulsed visible light embedded communication signal, the fixture photodetector receiving the another device issued pulsed visible light embedded communication signal having the processed motion and the identification of the at least one control icon;

the fixture controller retrieving from the fixture memory at least one of the element images or at least one operation assigned to the at least one control icon, the fixture controller transmitting a further fixture generated pulsed visible light embedded communication signal having the at least one element image or the at least one operation assigned to the at least one control icon;

the device photodetector receiving the further generated fixture pulsed visible light embedded communication signal having the at least one element image or the at least one operation assigned to the at least one control icon; and the device controller activating the device display and communicating the at least one element image or the at least one operation assigned to the at least one control icon onto the device display.

In a second alternative embodiment according to the first embodiment, the fixture controller compares the physical environment to the cyber environment and updates the cyber environment to reflect alteration of a location of the control icon within the cyber environment.

In a third alternative embodiment according to the second embodiment, the personal electronic device having a device projector in communication with the device display.

In a fourth alternative embodiment according to the third embodiment, the sensed motion is selected from the group essentially consisting of a gesture, an eye movement, a head movement, an arm movement, a leg movement, a rotational movement, a vertical movement, a swipe movement, and any combination thereof.

In a fifth alternative embodiment according to the fourth embodiment, the personal electronic device is transceiver glasses or goggles.

In a sixth alternative embodiment according to the fifth embodiment, the device identifier includes device location information.

In a seventh alternative embodiment according to the sixth embodiment, the device pulsed visible light embedded communication signal includes the device identifier.

In an eighth alternative embodiment according to the seventh embodiment, the fixture identifier includes fixture location information.

In a ninth alternative embodiment according to the eighth embodiment, the fixture pulsed visible light embedded communication signal includes the fixture identifier.

In a tenth alternative embodiment according to the ninth embodiment, each update of the cyber environment includes an update identification tag, the update identification tag including at least one of date, time and location.

In an eleventh alternative embodiment according to the tenth embodiment, at least one of the fixture memory and the fixture controller are in communication with an evolving database.

In a twelfth alternative embodiment according to the eleventh embodiment, a visible light embedded communication fixture has a plurality of fixture light emitting diodes generating light in the visible spectrum, a plurality of fixture ultraviolet light emitting diodes generating light in the ultraviolet spectrum, a fixture controller, a fixture memory, a fixture identifier and a fixture photodetector, the fixture photodetector receiving a received pulsed visible light embedded communication signal, the fixture controller regulating the plurality of fixture light emitting diodes generating light in the visible spectrum transmitting a fixture generated pulsed visible light embedded communication signal, the fixture memory having stored parameters regulating activation of the plurality of fixture ultraviolet light emitting diodes, the light in the ultraviolet spectrum providing germicidal irradiation to a surface, the received pulsed visible light embedded communication signal having a signal origin identifier and an activation authorization code permitting emission of the light in the ultraviolet spectrum, the fixture generated pulsed visible light embedded communication signal including the fixture identifier.

In a thirteenth alternative embodiment according to the twelfth embodiment, at least one sensor selected from the group essentially consisting of a light sensor, a motion detector, a heat source sensor, a temperature sensor, an air movement sensor, a sound sensor, and combinations thereof.

In a fourteenth alternative embodiment according to the thirteenth embodiment, at least one of the fixture controller, the fixture memory and the at least one sensor is in communication with an evolving database.

In a fifteenth alternative embodiment according to the fourteenth embodiment, the evolving database issues a command signal terminating emission of the light in the ultraviolet spectrum.

In a sixteenth alternative embodiment according to the fifteenth embodiment, an input device is in communication with the fixture controller, the input device authorizing emission of the light in the ultraviolet spectrum.

In a seventeenth alternative embodiment according to the first sixteenth, the input device is selected from the group essentially consisting of a keypad code, a thumb print scanner, a card reader, a palm scanner, a retinal scanner, a voice scanner, a biometric scanner and combinations thereof.

A more complete description of visible light embedded communications is disclosed in U.S. Pat. Nos. 6,879,263; 7,046,160; 7,439,847; 7,902,978; 8,188,861; 8,188,878; 8,188,879; 8,330,599; 8,331,790; 8,542,096; 8,543,505; 8,571,411; 8,593,299; 8,687,965; 8,744,267; 8,751,390; 8,886,045; 8,890,655; 8,890,773; 8,902,076; 9,100,124; 9,246,594; 9,252,883; 9,258,864; 9,265,112; 9,294,198; 9,318,009; 9,363,018; 9,412,142; 9,413,457; 9,413,459; 9,414,458; 9,455,783; 9,461,740; 9,461,748; 9,577,760; 9,654,163; 9,655,189; 9,660,726; 9,768,868; 9,755,743; 9,967,030; 10,050,705; 10,051,714; 10,090,925; 10,205,530; 10,250,329; 10,251,243; 10,374,706; 10,41,1746; 10,448,472; 10,521,801; 10,763,909; 10,812,186; 10,820,391; 10,911,144; 10,932,337; and 11,018,774; as well as U.S. patent application Ser. Nos. 11/433,979; 12/032,908; 12/126,342; 12/126,469; 12/126,647; 14/207,934; 14/290,152; 14/597,648; 15/132,753; 15/231,091; 15/233,282; 15/233,301; 15/275,848; 15/434,688; 16/144,713; 16/242,531; and 16/695,458; as well as U.S. Provisional Patent Application Ser. Nos. 60/248,894; 60/405,592; 60/405,379; 60/931,611; 61/165,546; 61/778,672; 61/783,501; 61/819,861; 61/867,731; 61/927,638; 61/927,663; 62/203,697 being authored and invented by applicant herein, the contents all of which being incorporated by reference in this application in their entireties.

This completes the description of the preferred and alternate embodiments of the invention. Those skilled in the art may recognize other equivalents to the specific embodiment described herein which equivalents are intended to be encompassed by the claims attached hereto.

The above disclosure is intended to be illustrative and not exhaustive. This description will suggest many variations and alternatives to one of ordinary skill in this art. The various elements shown in the individual figures and described above may be combined or modified for combination as desired. All these alternatives and variations are intended to be included within the scope of the claims where the term “comprising” means “including, but not limited to”.

These and other embodiments which characterize the invention are pointed out with particularity in the claims annexed hereto and forming a part hereof. However, for further understanding of the invention, its advantages and objectives obtained by its use, reference should be made to the drawings which form a further part hereof and the accompanying descriptive matter, in which there is illustrated and described embodiments of the invention.

I claim:

1. An infrastructural apparatus operating system comprising:
a personal electronic device having a device camera, a device sensor, a device controller, a device display, a device photodetector, a device identifier, and plurality of device light emitting diodes, said device camera observes a physical environment, said device controller regulating said plurality of device light emitting diodes transmitting images of said physical environment within a device issued pulsed visible light embedded communication signal, said images having element images;
a visible light embedded communication fixture having a plurality of fixture light emitting diodes, a fixture controller, a fixture memory, a fixture identifier and a fixture photodetector, said fixture photodetector receiving said device issued pulsed visible light embedded communication signal, said fixture controller storing said images and said element images in said fixture memory within a cyber environment, said fixture controller assigning control icons to said element images within said cyber environment, said fixture controller regulating said plurality of fixture light emitting diodes transmitting a fixture generated pulsed visible light embedded communication signal having said cyber environment and said control icons;
said device photodetector receiving said transmitted fixture generated pulsed visible light embedded communication signal having said cyber environment and said control icons, said device controller processing said fixture generated pulsed visible light embedded communication signal having said cyber environment and said control icons and transferring said cyber environment and said control icons onto said device display;
said device sensor detecting motion of said personal electronics device, and said device controller processing said motion and identifying at least one of said control icons, said device controller regulating said plurality of device light emitting diodes transmitting said processed motion and said identification of said at least one control icon within another device issued pulsed visible light embedded communication signal, said fixture photodetector receiving said another device issued pulsed visible light embedded communication signal having said processed motion and said identification of said at least one control icon;
said fixture controller retrieving from said fixture memory at least one of said element images or at least one operation assigned to said at least one control icon, said fixture controller transmitting a further fixture generated pulsed visible light embedded communication signal having said at least one element image or said at least one operation assigned to said at least one control icon;
said device photodetector receiving said further generated fixture pulsed visible light embedded communication signal having said at least one element image or said at least one operation assigned to said at least one control icon; and
said device controller activating said device display and communicating said at least one element image or said at least one operation assigned to said at least one control icon onto said device display.

2. The system according to claim 1, wherein said fixture controller compares said physical environment to said cyber environment and updates said cyber environment to reflect alteration of a location of said control icon within said cyber environment.

3. The system according to claim 2, said personal electronic device having a device projector in communication with said device display.

4. The system according to claim 3, wherein said sensed motion is selected from the group essentially consisting of a gesture, an eye movement, a head movement, an arm movement, a leg movement, a rotational movement, a vertical movement, a swipe movement, and any combination thereof.

5. The system according to claim 4, wherein said personal electronic device is transceiver glasses or goggles.

6. The system according to claim 5, wherein said device identifier includes device location information.

7. The system according to claim 6, wherein said device pulsed visible light embedded communication signal includes said device identifier.

8. The system according to claim 7, wherein said fixture identifier includes fixture location information.

9. The system according to claim 8, wherein said fixture pulsed visible light embedded communication signal includes said fixture identifier.

10. The system according to claim 9, wherein each update of said cyber environment includes an update identification tag, said update identification tag including at least one of date, time and location.

11. The system according to claim 10, wherein at least one of said fixture memory and said fixture controller are in communication with an evolving database.

12. An infrastructural apparatus operating system comprising:
a visible light embedded communication fixture having a plurality of fixture light emitting diodes generating light in the visible spectrum, a plurality of fixture ultraviolet light emitting diodes generating light in the ultraviolet spectrum, a fixture controller, a fixture memory, a fixture identifier and a fixture photodetector, said fixture photodetector receiving a received pulsed visible light embedded communication signal, said fixture controller regulating said plurality of fixture light emitting diodes generating light in the visible spectrum transmitting a fixture generated pulsed visible light embedded communication signal, said fixture memory having stored parameters regulating activation of said plurality of fixture ultraviolet light emitting diodes, said light in the ultraviolet spectrum providing germicidal irradiation to a surface, said received pulsed visible light embedded communication signal having a signal origin identifier and an activation authorization code permitting emission of said light in the ultraviolet spectrum, said fixture generated pulsed visible light embedded communication signal including said fixture identifier.

13. The system according to claim 12, further comprising at least one sensor selected from the group essentially consisting of a light sensor, a motion detector, a heat source sensor, a temperature sensor, an air movement sensor, a sound sensor, and combinations thereof.

14. The system according to claim 13, wherein at least one of said fixture controller, said fixture memory and said at least one sensor is in communication with an evolving database.

15. The system according to claim 14, wherein said evolving database issues a command signal terminating emission of said light in the ultraviolet spectrum.

16. The system according to claim 15, further comprising an input device in communication with said fixture controller, said input device authorizing emission of said light in the ultraviolet spectrum.

17. The system according to claim 16, wherein said input device is selected from the group essentially consisting of a keypad code, a thumb print scanner, a card reader, a palm scanner, a retinal scanner, a voice scanner, a biometric scanner and combinations thereof.
